(19) United States
(12) Patent Application Publication
(10) Pub. No.: US 2008/0086542 A1
(43) Pub. Date: Apr. 10, 2008

(54) System and method for communicating document information

(75) Inventors: Abhijit Mukherjee, Mount Laurel, NJ (US); Balaji Krishnamurthy, Plainsboro, NJ (US); Biswajit Sarkar, Franklin Township, NJ (US)

Correspondence Address: MCCARTER & ENGLISH, LLP, FOUR GATEWAY CENTER, 100 MULBERRY STREET, NEWARK, NJ, 07102, US

(73) Assignee: Title Resource Group, LLC

(21) Appl. No.: 11/542,851

(22) Filed: Oct. 4, 2006

(51) Int. Cl. G06F 15/16

(52) U.S. Cl. 709/219

(57) ABSTRACT

Disclosed herein are systems and methods for communicating document information from any one of a plurality of client systems to any one of a plurality of recipient systems. In an exemplary embodiment of the invention, a control system receives a first request to send first document information to a first recipient system set selected from a plurality of recipient systems having disparate communication protocols, as well as a second request to send second document information to a second recipient system set selected from the plurality of recipient systems. The first and second requests are received into a queue, and the control system polls the queue using a multithreaded process to extract the first and second request. A multithreaded process is used to send the first document information to the first recipient system set and the second document information to the second recipient system set.

### FIELD OF THE INVENTION

The present invention relates generally to systems and methods for communicating document information. In particular, preferred embodiments of the present invention relate to systems and methods for communicating document information from a plurality of client systems to a plurality of recipient systems having disparate communication protocols.

### BACKGROUND OF THE INVENTION

It is known in the art to send a document from an application of a client system, such as a home or office computer, to a recipient system, such as another computer or a fax machine. For example, it is known in the art to use a word processing application to send document information therefrom to software for communicating the document information to a fax machine in a format corresponding thereto. It is further known in the art that document information can be forwarded from the application of the client system to another computer by way of software for e-mailing the document information in the application's native format and/or in a portable document format (PDF).

Although it is suspected that the software described above has achieved some degree of commercial success, it has been considered by some to be unsatisfactory in the business context, where large scale operations and the efficiencies of scale are a necessity. However, processing document information at the client system typically introduces latency, increasing client waiting periods. Also, processing document information at the client system can preset compatibility issues due to disparate operating systems and/or incompatible software components, and interfacing with external devices, e.g., faxes, printers, databases, servers, etc., presents special considerations for client systems. Furthermore, processing document information at the client side enhances system complexity at least from the perspective of enforcement of security policies and other business logics.

What is needed in the art is a system and method for facilitating the efficient communication of document information from a plurality of client systems to a plurality of recipient systems in a plurality of recipient formats.

### SUMMARY OF THE INVENTION

The present invention overcomes the disadvantages and shortcomings of the prior art by providing systems and methods for communicating document information, whereby a request is received at a control system for communication to one or more recipient systems selected from a group thereof having disparate communication protocols. The request is preferably passed to a queue, and, after the queue is polled, the document information associated with the request is emulated for dispatch to the recipient system(s) associated with the request.

The request, which is preferably a reference pointer, originates with a client system having a graphical user interface (UI) displayed to a user who identifies the document information to be transmitted, as well as the recipient system(s) to which such document information is to be transmitted. The document information preferably includes that data which is typically associated with a document, e.g., an electronic document, regardless of the native format of the document. The recipient system includes any suitable communications system, e.g., a facsimile machine, a desktop computer system having e-mail capabilities, a voicemail system, etc. The UI preferably includes an interactive display showing personal and/or company “contacts” selectable by the user to designate the chosen recipient system.

The exemplary embodiment of the present invention preferably incorporates multitasking techniques accomplished by a multithreaded process. In the exemplary embodiment of the invention, at least a second request is received at the control system. The second request is associated with second document information and a second recipient system set selected from the plurality of recipient systems.

In the exemplary embodiment, the control system queues the requests into a queue in accordance with business logic thereof. As used herein, the term “queue” refers broadly to any suitable data structure, such as a table, and the term “queuing” refers broadly to the process of receiving and/or positioning data with respect to the data structure. The requests are preferably queued at an application database server, while the document information preferably resides at one or more nodes of a Storage Area Network (SAN) that includes a plurality of web servers, remote servers, file servers, client servers, etc.

The queue is polled using multithreading techniques to extract the requests in accordance with the rules of the queue. Each request has associated therewith an instance of a service agent that, among other things, is tailored toward the requirements of the recipient system (e.g., fax, e-mail, etc.) associated with the request. The service agent retrieves the document information associated with the request and processes the request in accordance with business rules selected by the user. For example, the selected business rules can be that the document information is to be merged with additional information, e.g., a coversheet, to be sent to the recipient system set. As another example, digital rights management (DRM), password protection, and/or watermarking techniques can be applied to password-protect the document information. Service agents dispatch the document information to transmission servers for sending the document information to the recipient system(s) associated with the request for the document information.

In the exemplary embodiment of the present invention, the control system “tracks” communication of the document information to the recipient systems and notifies the user via the client system of whether the document information has been successfully communicated. A UI screen for tracking is displayable to the user at the client system for such purposes.

### BRIEF DESCRIPTION OF THE DRAWINGS

For a more complete understanding of the present invention, reference is made to the following detailed description of exemplary embodiment(s) considered in conjunction with the accompanying drawings, in which:

FIG. 1 is a network diagram showing a communications network that includes a plurality of client systems including a desktop computer system and a wireless laptop computer system, a plurality of recipient systems, including a fax recipient system, an e-mail recipient system, a voicemail recipient system, and another recipient system, and a control system having a plurality of web servers, a plurality of mid-tier servers, a plurality of framework servers, an applications database server, a framework database server, and a plurality of transmission servers, including a fax server, an e-mail server, a server for text-to-voice communications, and another transmission server;

FIG. 2 is a software architecture diagram showing modules for implementing an exemplary method of the present invention, including a user interface (UI), an applications database, a Poller object, a Dispatcher object, and a plurality of service agent modules;

FIG. 3 is a software architecture diagram showing interaction between the Poller object, the Dispatcher object, and the service agents of FIG. 2 with an application database and a framework database resident respectively on the application database server and the framework database server of FIG. 1;

FIGS. 4A-B are sections of a flow chart that is distributed across FIGS. 4A-B, wherein the flow chart shows an exemplary process flow of the communications method from a UI-perspective;

FIG. 5 is a screen shot of a document delivery page of the UI showing a “Document Delivery” tab being activated, wherein the screen shot shows a documents identification panel, a contacts identification panel, a delivery methods panel, a cover sheet panel, and a request summary panel;

FIG. 6 is a screen shot of the document delivery page showing a document package being selected with the document identification panel;

FIG. 7 is a screen shot of the document delivery page showing a plurality of documents being selected with the document identification panel from the document package of FIG. 6;

FIG. 8 is a screen shot of the document delivery page showing contacts being selected with the contacts identification panel;

FIG. 9 is a screen shot of the document delivery page showing e-mail selected as a communications protocol, the request summary panel displaying the selected document package, the selected documents of the document package, the selected delivery methods, and the recipient destination addresses corresponding thereto;

FIG. 10 is a screen shot of the document delivery page showing a facsimile and default fax cover sheet being selected;

FIG. 11 is a screen shot of the document delivery page showing a facsimile and custom cover sheet being selected;

FIG. 12 is a screen shot of the document delivery page showing with a window for receiving cover sheet information from a user for the custom cover sheet of FIG. 11;

FIG. 13 is a screen shot of the document delivery page showing the request summary panel with multiple job requests;

FIG. 14 is a screen shot of the first interactive display with a window indicating that delivery has been successful;

FIG. 15 is a screen shot of a tracking page showing a “Tracking” tab being activated, wherein the screen shot shows an order status panel and an order retrieval panel with a drop-down menu;

FIG. 16 is a screen shot of the second interactive display showing the drop-down menu of the order retrieval panel being activated to show selectable options thereof;

FIGS. 17A-B are sections of a sequence diagram that is distributed across FIGS. 17A-B, wherein the sequence diagram shows an exemplary process flow, including, among other things, a Document Delivery Page object, a CoverSheet UI object, a Document Delivery Class object, a Document Delivery DB Processor object, a DataBase object, the Poller object, a Framework DB object, the Dispatcher object, a DocConverter service agent object, and a DocDelivery service agent object;

FIG. 18 is a sequence diagram showing the DocConverter service agent object of FIG. 17B with further detail;

FIG. 19 is a sequence diagram showing the DocDelivery service agent object of FIG. 17B with further detail; and

FIG. 20 is a sequence diagram showing an exemplary process flow in connection with a Tracking Screen object, a Tracking Class object, a Tracking DBProcessor object, and the DataBase object; and

FIG. 21 is a sequence diagram showing an exemplary process flow of a method for changing a password in connection with a Password Change object, a PasswordChangeClass object, a DBChange password object, and the DataBase object.

### DETAILED DESCRIPTION OF THE EXEMPLARY EMBODIMENTS OF THE INVENTION

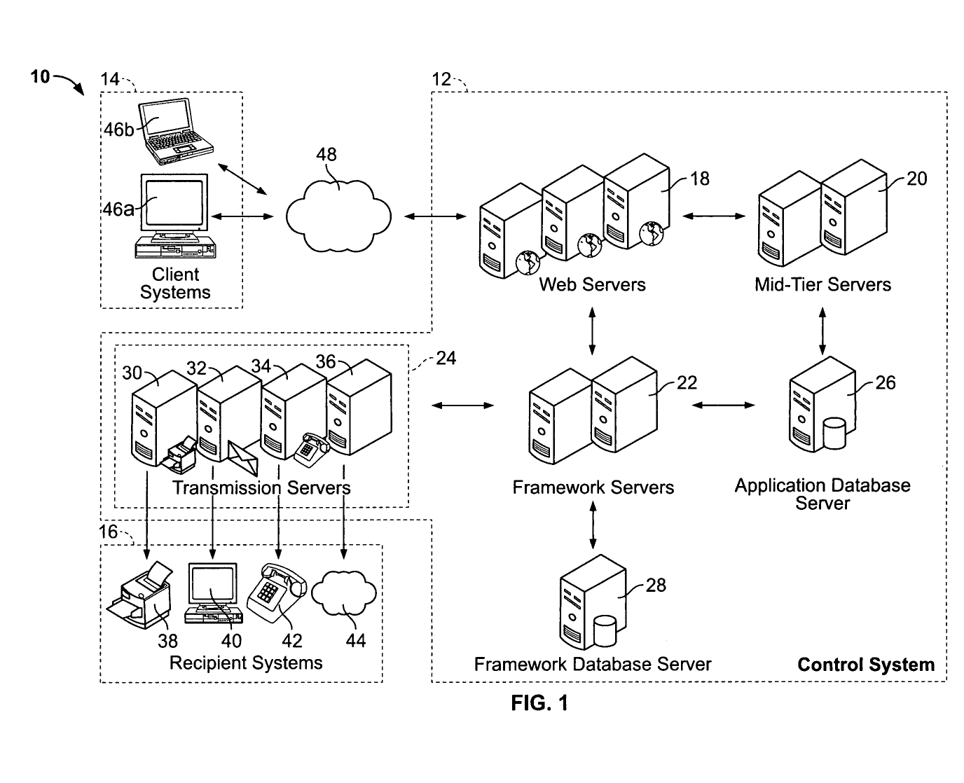

Referring to FIG. 1, a communications network 10 is shown to include a control system 12 constructed in accordance with an exemplary embodiment of the invention. The communications network 10 further includes a plurality of client systems 14 and a plurality of recipient systems 16.

The control system 12 includes a plurality of web servers 18, a plurality of mid-tier servers 20, a plurality of framework servers 22, a plurality of transmission servers 24, a database server that is referenced herein as an application database server 26, and a database server that is referenced herein as a framework database server 28. The client systems 14, the recipient systems 16, the web servers 18, the mid-tier servers 20, the framework servers 22, the transmission servers 24, the application database server 26, and the framework database server 28 shall each be discussed with further detail below.

The web servers 18 are in communication with the client systems 14 and have a client-server relationship therewith. The client systems 14 include any suitable computing device having a processor, an at least temporary memory device, a network interface device, a display, a user input device, etc. For the example, the client systems 14 can include a desktop computer 46a and/or a laptop computer 46b which connect to the web servers 18 through a network 48 that is wireless and/or wired. It is contemplated that the client systems 14 can include any suitable hardware and/or software for implementing the methods described herein.

As will be discussed in further detail below, the web servers 18 host the UI enabling users of the client systems 14 to select those documents having document information to be communicated, to select those the recipient systems 16 to receive the document information, etc. Exemplary embodiments of the present invention are application-agnostic and can be used as a stand-alone utility. However, it is contemplated that the UI can be launched directly from an application that uses documents, such as Microsoft Word, Microsoft Excel, Adobe Acrobat, etc. The UI can be launched from a real estate and/or title service management application, such as iClosings. In exemplary embodiments of the present invention, the application, the documents, and the document information thereof are stored on the web servers 18 and/or another node of a Storage Area Network (SAN) that includes the web servers 18 and/or file servers, client servers, remote servers, etc. (not shown).

Each one of the web servers 18 is preferably an IBM 346 server having two central processing units (CPUs), at least four gigabytes of random access memory (RAM), and at least one network interface device. Each one of the web servers 18 has a Windows 2003 OS Standard Edition operating system for hosting the UI and preferably runs IIS Version 6.0 software. Although three web servers 18 are preferable, it is contemplated that any suitable number of web servers 18 can be used. It is further contemplated that the web servers 18 can include any hardware and/or software suitable for implementing the methods described herein.

The mid-tier servers 20 are preferably in direct communication with the web servers 18. The mid-tier servers 20 receive a user request from the web servers 20 for delivery of document information and create a job request for further processing as described herein (e.g., for queuing, polling, dispatching, etc.). Each one of the mid-tier servers 20 is preferably an IBM 366 server having two CPUs, at least four gigabytes of RAM, and at least one network interface device. Each one of the mid-tier servers 18 have a Windows 2003 OS operating system for hosting various software modules described herein. Although two mid-tier servers 20 are preferable, it is contemplated that any suitable number of mid-tier servers 20 can be used. It is further contemplated that the mid-tier servers 20 can include any hardware and/or software suitable for implementing the methods described herein.

Continuing with reference to FIG. 1, the application database server 26 is preferably in direct communication with the mid-tier servers 20 and, through a switch thereof, the web servers 18. As will be discussed in further detail below, the job requests created at the mid-tier servers 20 are received into a queue at the application database server 26 for further processing. The application database server 26 preferably includes an IBM 366 server having four CPUs, at least eight gigabytes of RAM, and at least one network interface device. Although a single application database server 26 is preferred, it is contemplated that the methods of the present invention can be implemented by more than one application database server 26. It is further contemplated that the application database server 26 can include any hardware and/or software suitable for implementing the methods described herein.

The framework servers 22 are preferably in direct communication with the web servers 18 and the application database server 26. As will be discussed in further detail below, the framework servers 22 have resident thereon a Poller object for polling job requests contained within the queue of the application database server 26 and breaking up each job request into multiple service requests to be queued at the framework database server 28. Also discussed in further detail below, the framework servers 22 have resident thereon a Dispatcher object and service agents that, among other things, retrieve document information from the SAN that has an association with the service request.

Continuing with reference to FIG. 1, each one of the framework servers 22 is preferably an IBM 366 server having two CPUs, at least four gigabytes of RAM, and at least one network interface device. Each one of the framework servers 22 has a Windows 2003 OS operating system for hosting various software modules described herein. Although two framework servers 22 are preferable, it is contemplated that any suitable number of framework servers 22 can be used. It is further contemplated that the framework servers 22 can include any hardware and/or software suitable for implementing the methods described herein.

The framework database server 28 is preferably in direct communication with the framework servers 22. As indicated above, the service requests created at the framework servers 22 are received into a secondary queue at the framework database server 28 for further processing. The framework database server 28 preferably includes an IBM 366 server having four CPUs, at least eight gigabytes of RAM, and at least one network interface device. Although a single framework database server 28 is preferred, it is contemplated that the methods of the present invention can be implemented by more than one framework database server 28. It is further contemplated that the framework database server 28 can include any hardware and/or software suitable for implementing the methods described herein.

The transmission servers 24 receive the service requests with document information from the framework servers 22. The transmission servers 24 include a fax server 30 and an e-mail server 32. The fax server 30 and the e-mail server 32 each preferably include an IBM 346 server having two CPUs, at least four gigabytes of RAM, and at least one network interface device. The fax server 30 preferably has RightFax 8.5 software resident thereon. It is contemplated that the transmission servers 24 can include a server for text-to-voice communications, referenced herein as a voice server 34, and can further include an additional transmission server 36 for scalability into additional communications formats. The transmission servers 24 can include any hardware and/or software suitable for implementing the methods described herein.

The recipient systems 16 preferably include a fax recipient system 38 and an e-mail recipient system 40. Moreover, it is contemplated that the recipient systems 16 can include a voicemail recipient system 42, as well as an additional recipient system 44 of another communications format, which is shown to be represented by a cloud in FIG. 1. The fax recipient system 38 is in communication with the fax server 30, and the e-mail recipient system 40 is in communication with the e-mail server 32. Furthermore, it is contemplated that the voicemail recipient system 42 can be in communication with the voice server 34, and the additional recipient system 44 can be in communication with the additional transmission server 36.

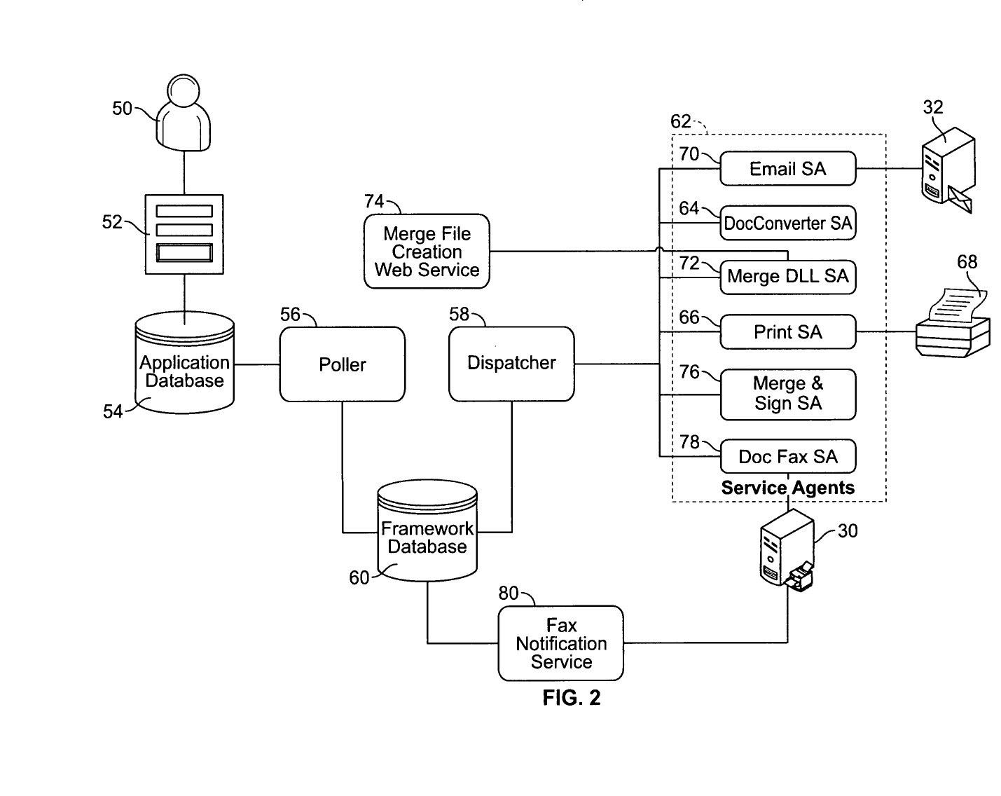

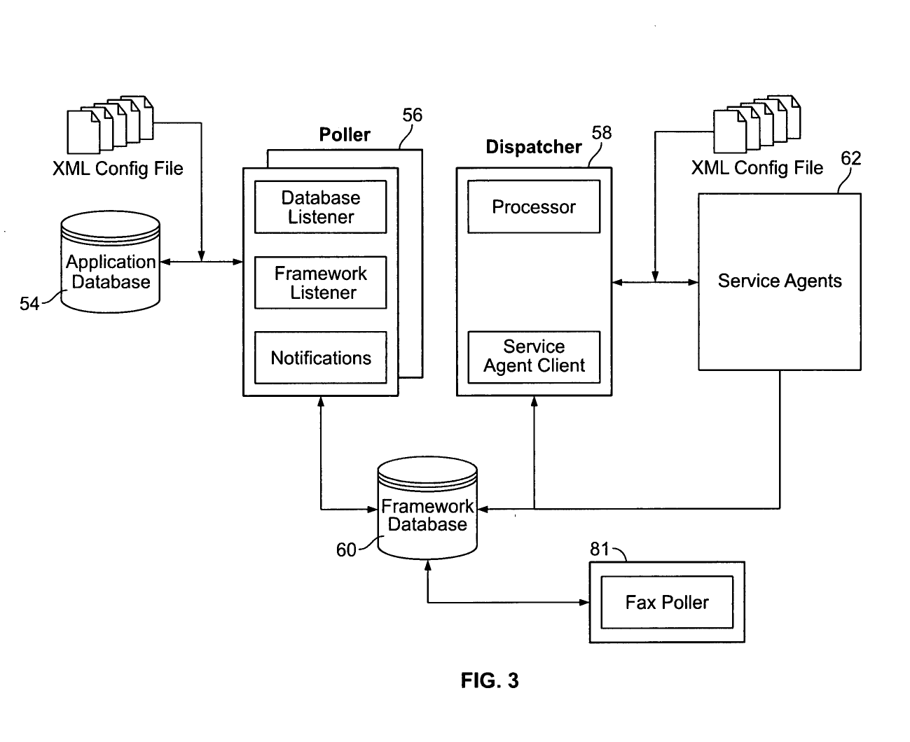

Referring to FIGS. 2 and 3, software architecture diagrams are shown to illustrate some of the primary modules of the control system 12. A user 50 operating one of the client systems 14 of FIG. 1 can log onto the web servers 18, whereby the user interface 52 is presented for interaction with the user 50. Interactions between the user 50 and the user interface 52 shall be described in further detail below. It is with the user interface 52 that the user 50 can identify documents for delivery and those of the recipient systems 16 which are to receive the document information. In response to a user request, the mid-tier servers 20 create a job request and pass the job request to an application database 54 resident on the server 26 for same, where the job request is queued. The application database 54 preferably utilizes SQL Server 2000 in a Windows 2003 Enterprise Edition platform.

The job request undergoes processing in connection with a Poller object 56, a Dispatcher object 58, and plurality of service agents 62. In an exemplary embodiment of the present invention, the Dispatcher object 58, the Poller object 56, and at least some of the service agents 62 alleviate problems associated with conventional high-latency synchronous processes.

The Poller object 56 preferably provides a multi-threaded service such that multiple job requests (and/or service requests) can be processed substantially concurrently with one another. The Poller object 56 loads job requests from the application database 54 and breaks the job requests into service requests, e.g., workflow tasks, for secondary queuing in a framework database 60 resident on the server 28 therefore. The Poller object 56 can be horizontally and/or vertically scaled to handle multiple databases and multiple requests. In this regard, it is contemplated that each application database 54 and/or server 26 therefore can be associated with a dedicated Poller object or reuse the existing Poller object 56.

As shown in FIG. 3, the Poller object 56 includes a database listener that loops to identify when a job request is to be received from the queue of the application database 54, a framework listener that loops to identify when a service request is to be received from the secondary queue of the framework database 60, and a notification service that facilitates notification to the user 50 concerning successful/unsuccessful transmissions of document information. Communications between the application database 54 of the server 26 therefore and the Poller object 56 of the framework database 60 of the server 28 therefore are implemented using an XML configuration file. The Poller object 56 shall be discussed with further detail below.

Continuing with reference to FIGS. 2 and 3, the Dispatcher object 58 preferably provides a multi-threaded service such that multiple service requests can be processed substantially concurrently with one another. The Dispatcher object 58 contains classes that retrieve service requests from the secondary queue of the framework database 60, adds the service requests to a tertiary queue, and assigns threads for a task the one of the service agents 62 responsible for such task. The Dispatcher object 58 can be load-balanced and/or can be scaled horizontally and/or vertically.

In the exemplary embodiment of the invention, the Dispatcher object 58 provides for recovery logic, and purges the framework database 60 for old service requests. Preferably, the Dispatcher object 58 automatically recovers and retries any failed jobs. Intelligence is built into the Dispatcher object 58 that is based on error type, and the Dispatcher object 58 can recover a failed job, retry a failed job, and, if an error type and/or message indicates that the failed job cannot succeed, abort the failed job.

The service agents 62 are generally used to retrieve document information from the SAN and/or process such document information for communication to one or more of the transmission servers 24. The service agents 62 run physically local to the Dispatcher object 58, e.g., on the framework servers 22, and it is contemplated that the service agents 62 can run as a remote service with respect to the Dispatcher object 58. In this regard, the Dispatcher object 58 is configured accordingly to call the service agents 62 regardless of their physical residence.

The service agents (SAs) 62 include, for example, a DocConverter SA object 64, a print SA object 66, an Email SA object 70, a Merge DLL SA object 72, a PDF_Merge & Sign SA object 76, and a DocFax SA object 78. The Merge DLL SA object 72 implements Microsoft Word Mail Merge using Word and third components by merging and emulating client behavior. The PDF_Merge & Sign SA object 76 merges multiple PDF files to a single PDF file for use of same in an e-mail or fax transmission. The PDF_Merge & Sign SA object 76 incorporates digital rights management technology into the file, such as watermarking, password protection, etc.

The DocConverter SA object 64 converts, for example, a Word document, Images, Reports, ASP/ASP.NET Pages into PDF using client-side emulation at the server side. The e-mail SA object 70 sends e-mails to the transmission servers 24 with (or without) attachments containing document information. The DocFax SA object 78 sends document information in a format suitable for facsimile to the fax transmission server 30, in which RightFax software is preferably resident. In this regard, the print SA object 66 sends document information to a network printer 68. The DocConverter SA object 64, the print SA object 66, the e-mail SA object 70, the Merge DLL SA object 72, the PDF_Merge & Sign SA object 76, and the DocFax SA object 78 shall each be discussed in further detail below.

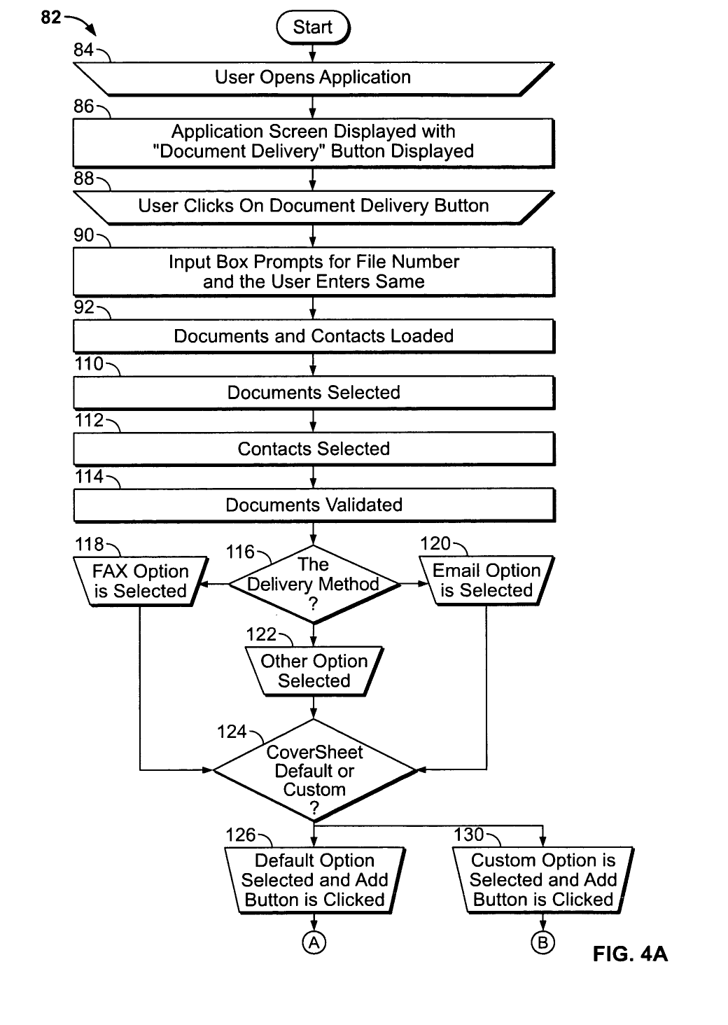

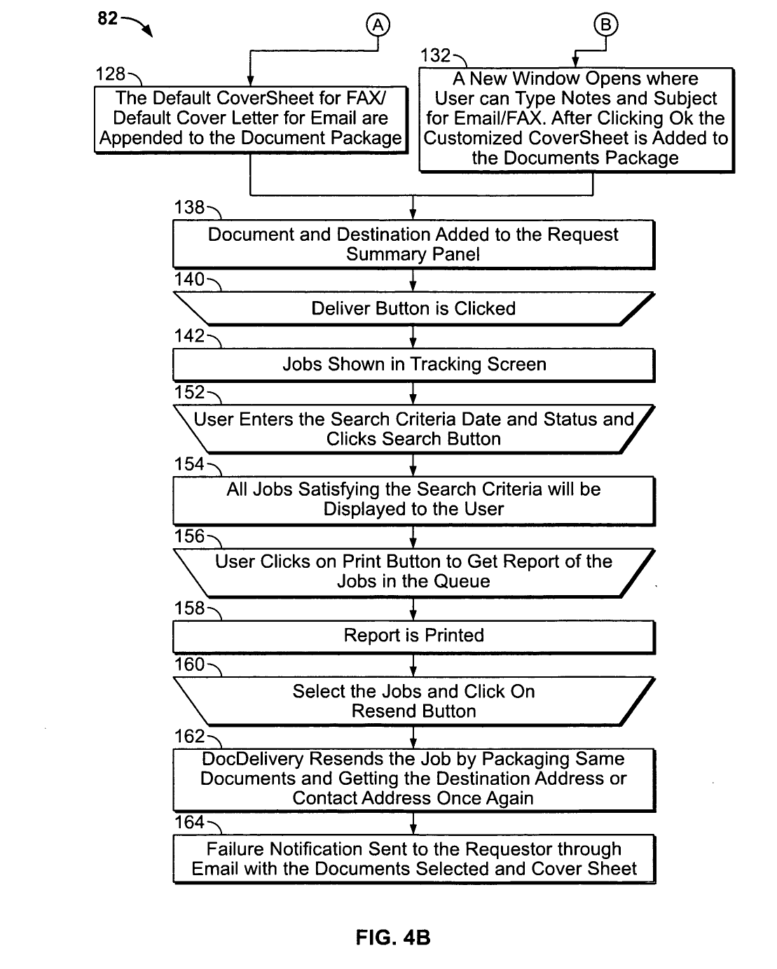

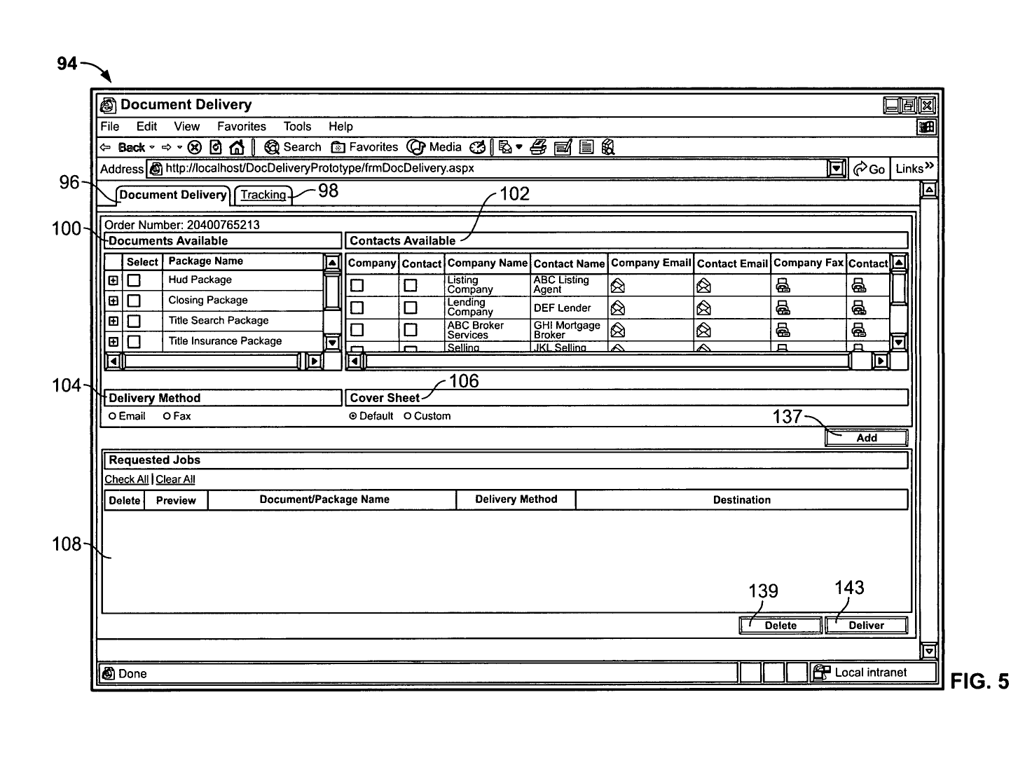

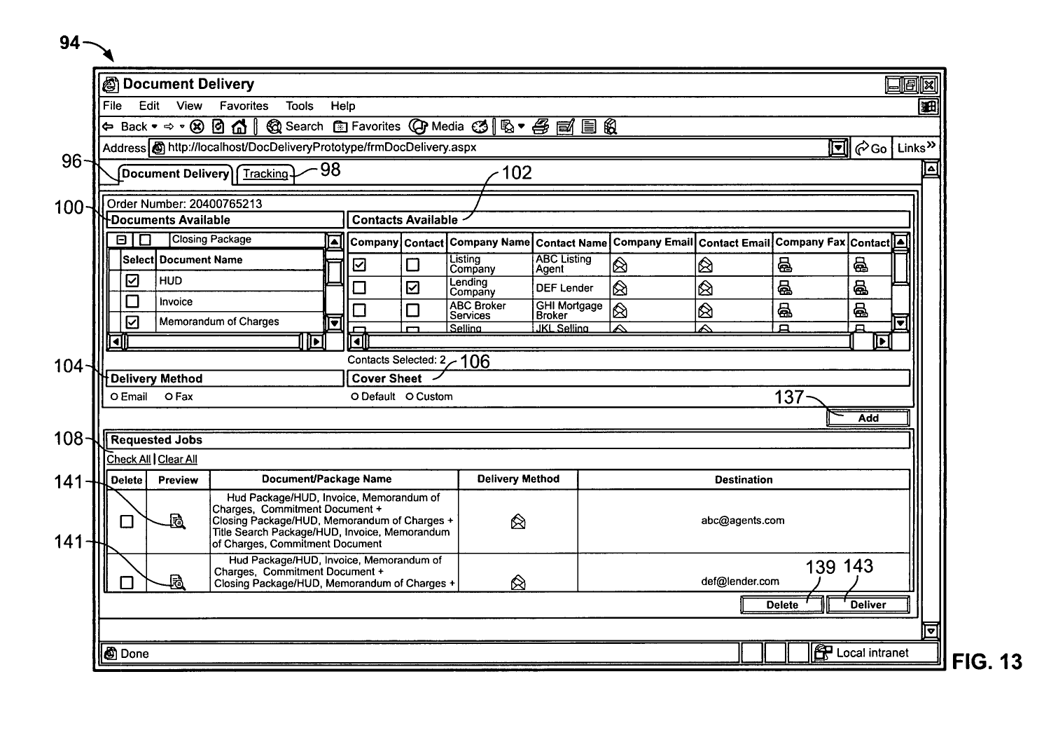

Referring to the flow chart of FIGS. 4A-4B and the screen shots of FIGS. 5-16, an exemplary communications method 82 shall be discussed from a UI-perspective. In step 84 of the communications method 82, the user 50 launches a document management application, such as Microsoft Word, Microsoft Excel, iClosings, etc., and, in step 86, the application is presented to the user 50 on a display of the client system 12. From step 86, the communications method proceeds to step 88, which is further discussed below. It is contemplated that the present invention can function as a stand-alone, application-agnostic utility, and steps 84 and 86 are considered optional, such that the communications method 82 can begin with step 88 discussed below.

In step 88 of the communications method 82, the user 50 launches an order number screen (not shown) for entering an order number, file name, etc. by pressing a button referenced herein as a “Document Delivery” button. In embodiments of the invention including steps 84 and 86 of the communications method 82, such launch can be initiated by pressing a macro embedded in the application. However, it is contemplated that such launch can be initiated by directly running an executable file associated with the order number screen.

From step 88, the communications method 82 proceed to step 90. In step 90, an input box prompts the user 50 for an order number, file number, etc., and the user 50 enters same. In step 92, the documents and contacts associated with the order number, file number, etc. are loaded.

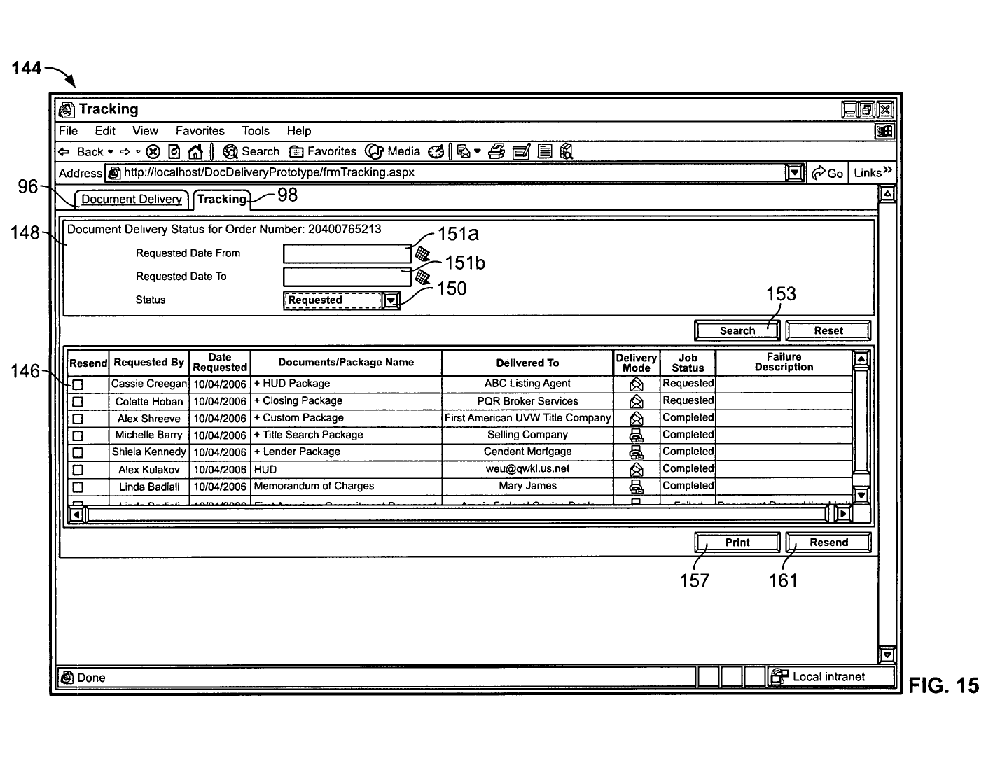

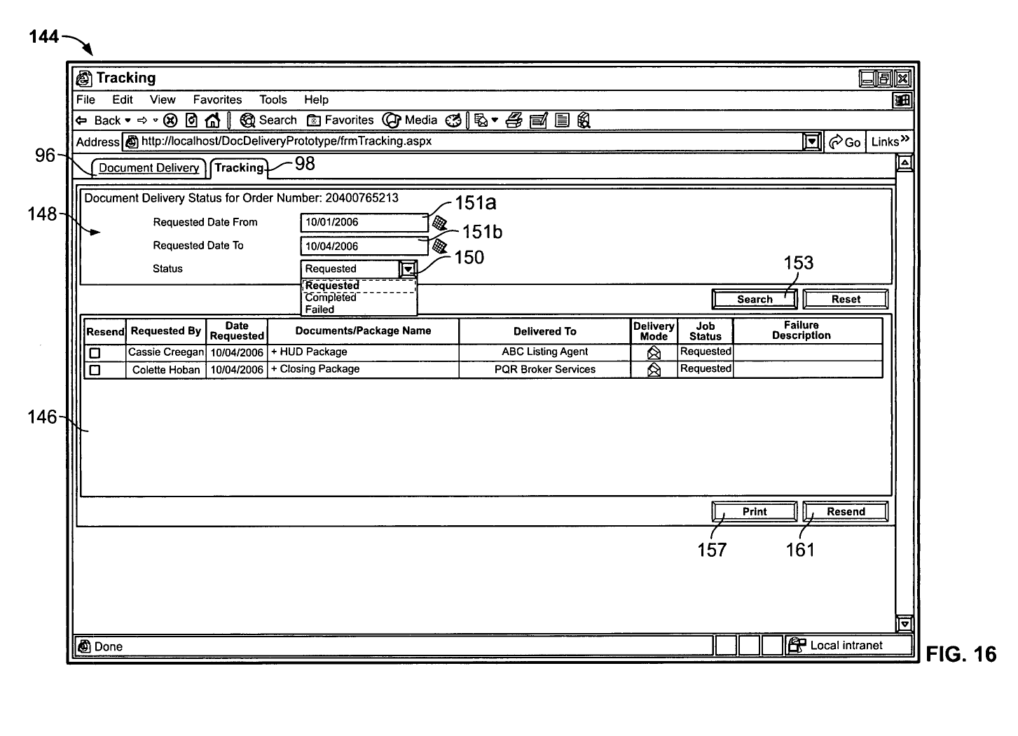

An interactive display, referenced herein as a Document Delivery Page 94, is presented to the user. The Document Delivery Page 94 includes a “Document Delivery” tab 96 and a “Tracking” tab 98, which, when actuated, respectively display and switch between the Document Delivery Page 94 of FIGS. 5-14 and a second interactive display (a tracking page) shown in FIGS. 15-16.

Referring to FIG. 5, the Document Delivery Page 94 includes a documents identification panel 100, a contacts identification panel 102, a delivery methods panel 104, a cover sheet panel 106, and a request summary panel 108. The documents identification panel 100 enables the user 50 to select those document packages, and the documents thereof, that the user 50 desires to send, while the contacts identification panel 102 enables the user 50 to select those contacts (recipients) to which document information is to be sent (e.g., that document information which is associated with the selected document packages and/or documents thereof). The delivery methods panel 104 enables the user 50 to select one of the recipient systems 16 (e.g., fax, e-mail, etc.) associated with a selected contact, while the cover sheet panel 106 enables the user 50 to select a type of cover sheet to accompany communication of the document information to the recipient systems 16 selected with the contacts identification panel 102. As will be discussed with further detail below, the request summary panel 108 shows those requests of the user 50 for which delivery is to be requested.

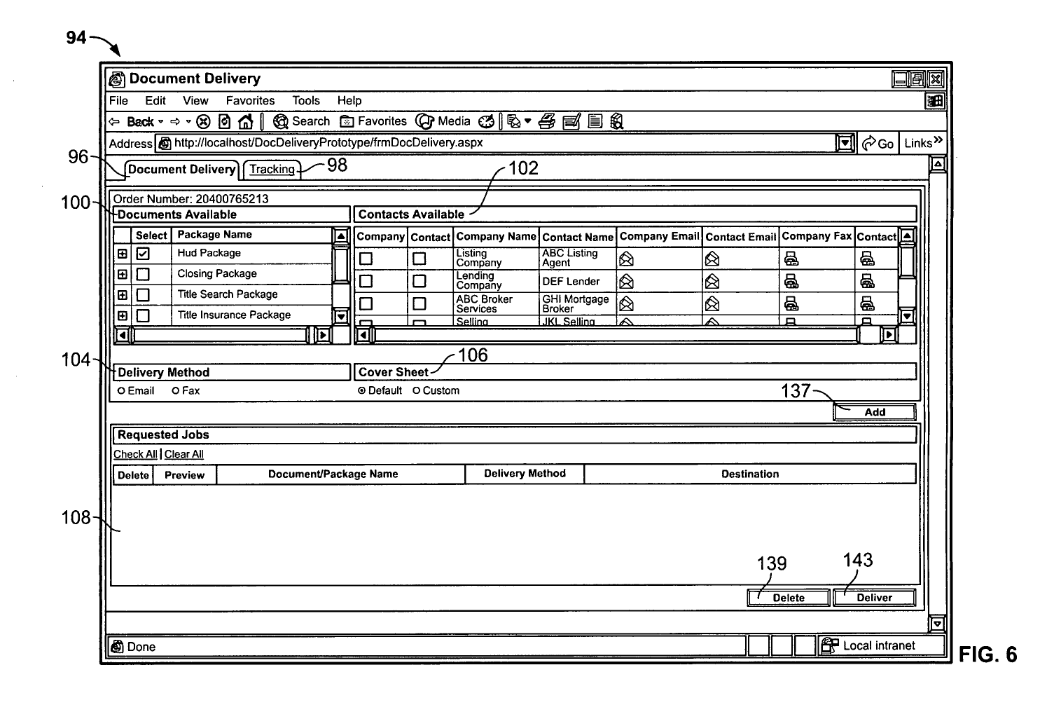

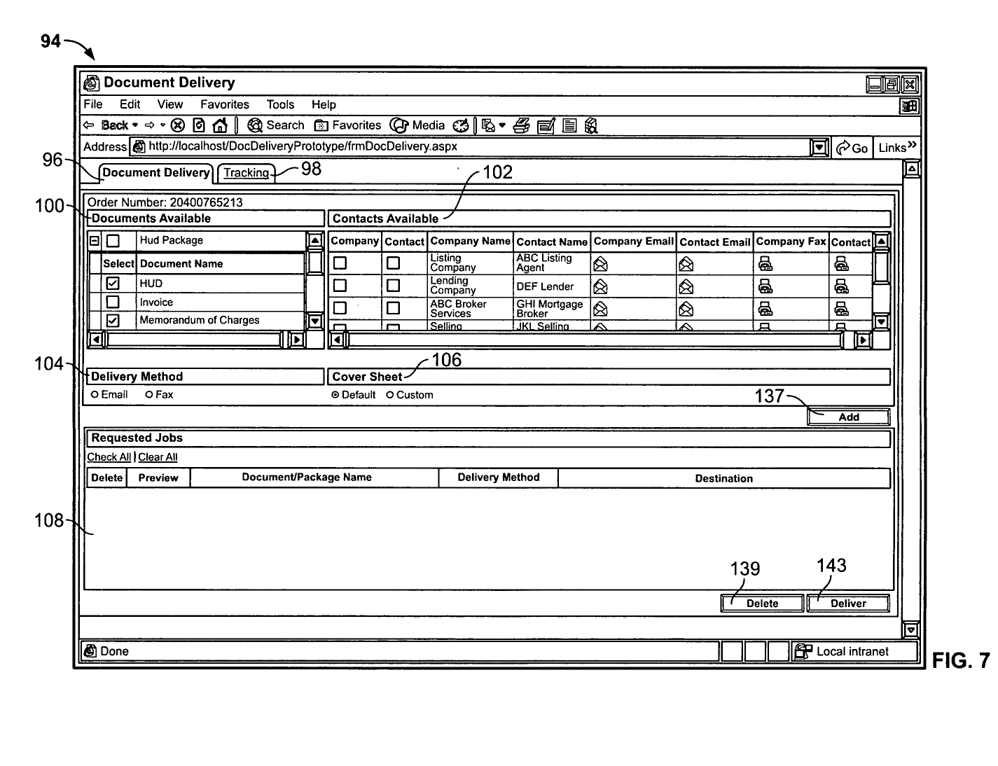

Referring to FIGS. 4A, 6, and 7, the communications method 82 proceeds from step 92 to step 110, where the user 50 selects the document information for delivery from the documents identification panel 100. More particularly, as shown in the Document Delivery Page 94 of FIG. 6, the user 50 selects one or more document packages by selecting the boxes next to the document packages, and, as shown in the Document Delivery Page 94 of FIG. 7, the user 50 selects one or more documents from each of the selected document packages by selecting the boxes next to the documents. The communications methods 82 proceeds from step 110 to 112.

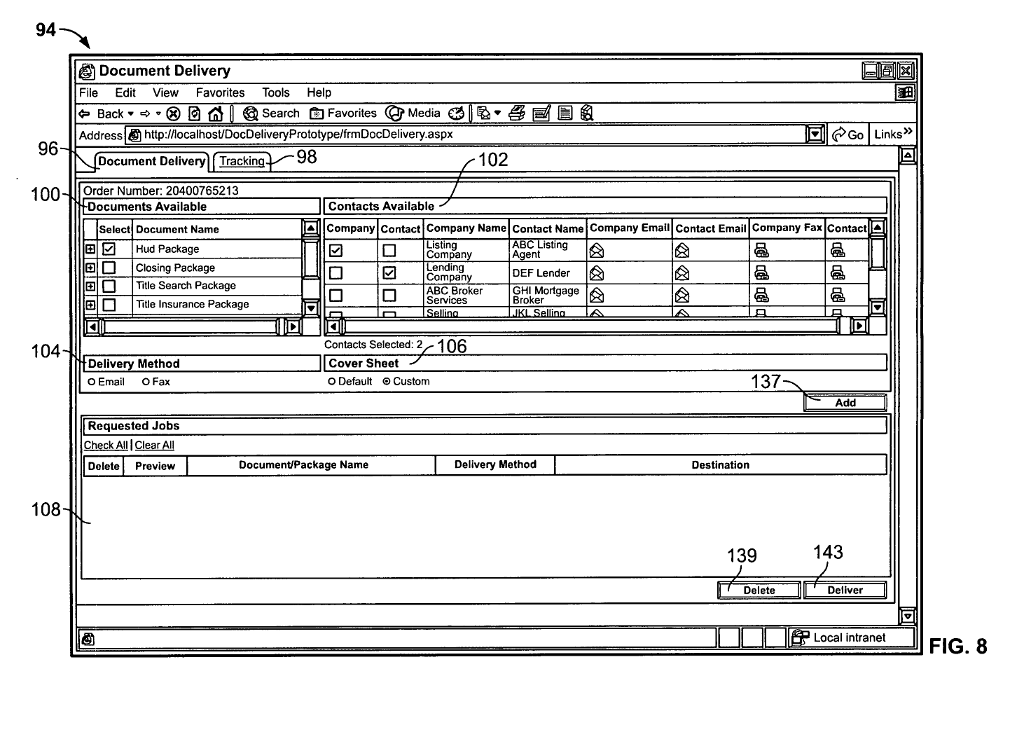

Referring to FIGS. 4A and 8, in step 112, the user 50 selects the contacts and delivery methods therefore from the contacts identification panel 102 and the delivery methods panel 104, respectively. More particularly, in step 112, and as shown in the Document Delivery Page 94 of FIG. 8, the user 50 selects a general company contact and/or a personal company contact by clicking a box displayed in connection with the company name, the personal contact name, the general company contact e-mail address, the personal contact e-mail address, the general company fax number, the personal contact fax number, etc. In step 114, the selected document packages and/or documents therefore are validated and the communications method 82 proceeds to step 116.

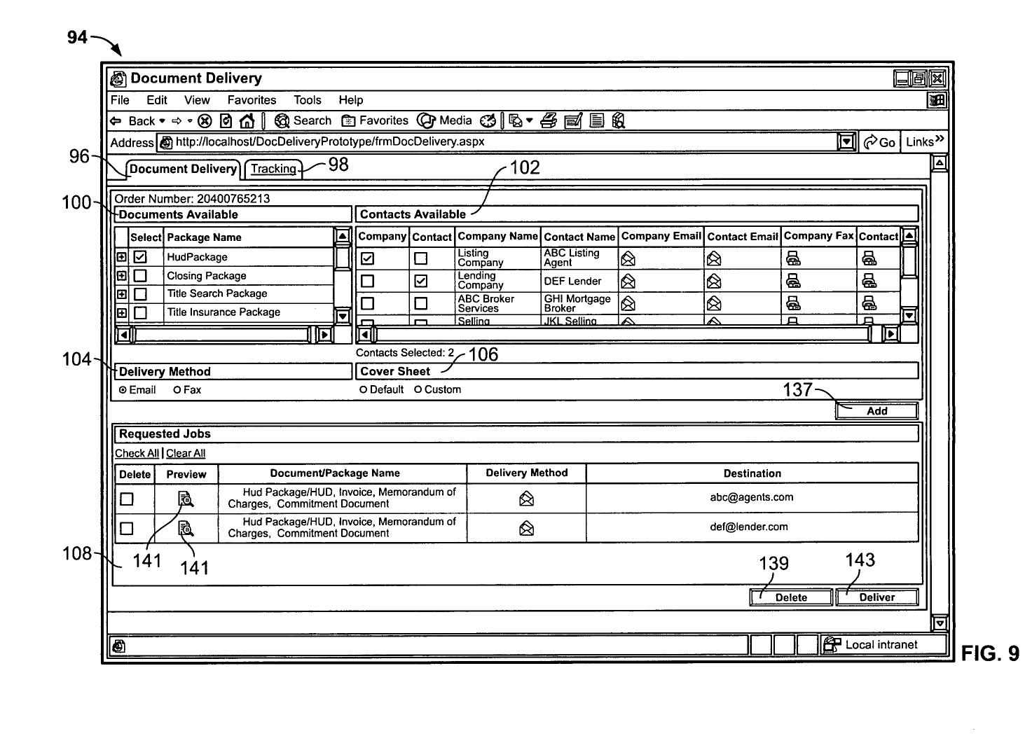

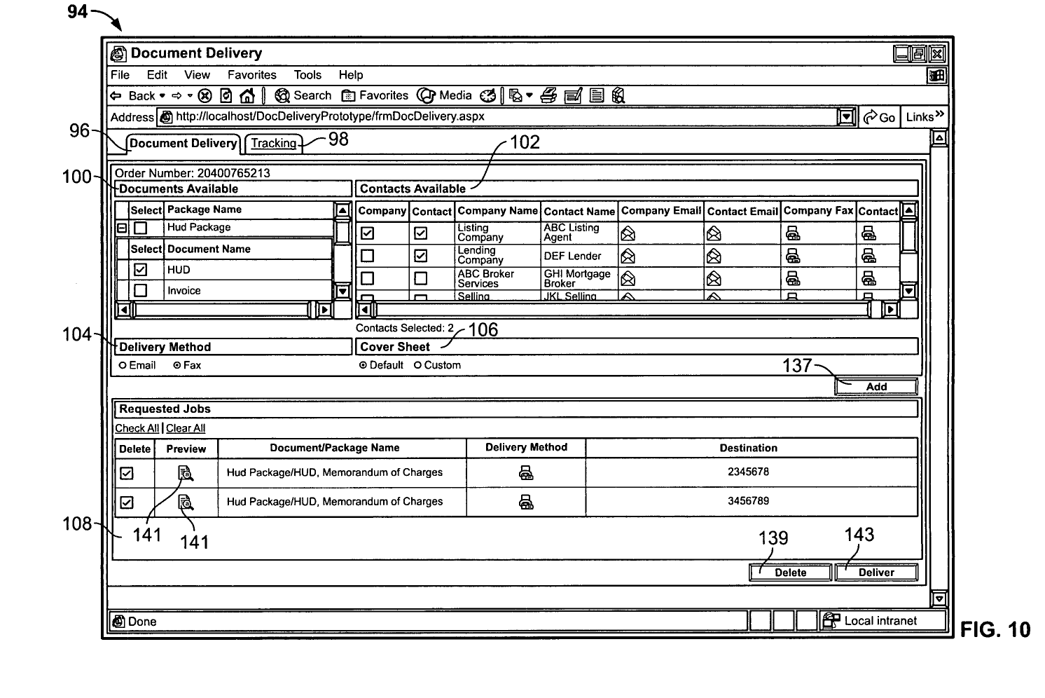

Referring to FIGS. 4A, 9, and 10, in step 116, the control system 12 awaits selection of a delivery method by the user 50 with the delivery methods panel 104. For example, in step 120 and as shown in FIG. 9, the control system 12 receives an indication from the UI that the user 50 has selected “e-mail” as the delivery method, e.g., communications protocol. In another example, in step 118 and as shown in FIG. 10, the control system 12 receives an indication from the UI that the user 50 has selected “fax” as the delivery method. It is contemplated that, in step 122, the control system 12 can accept requests for communication of document information by other communications protocols, e.g., a voice-to-text message sent to voicemail. From steps 118, 120, and 122, the communications method 82 proceeds to step 124.

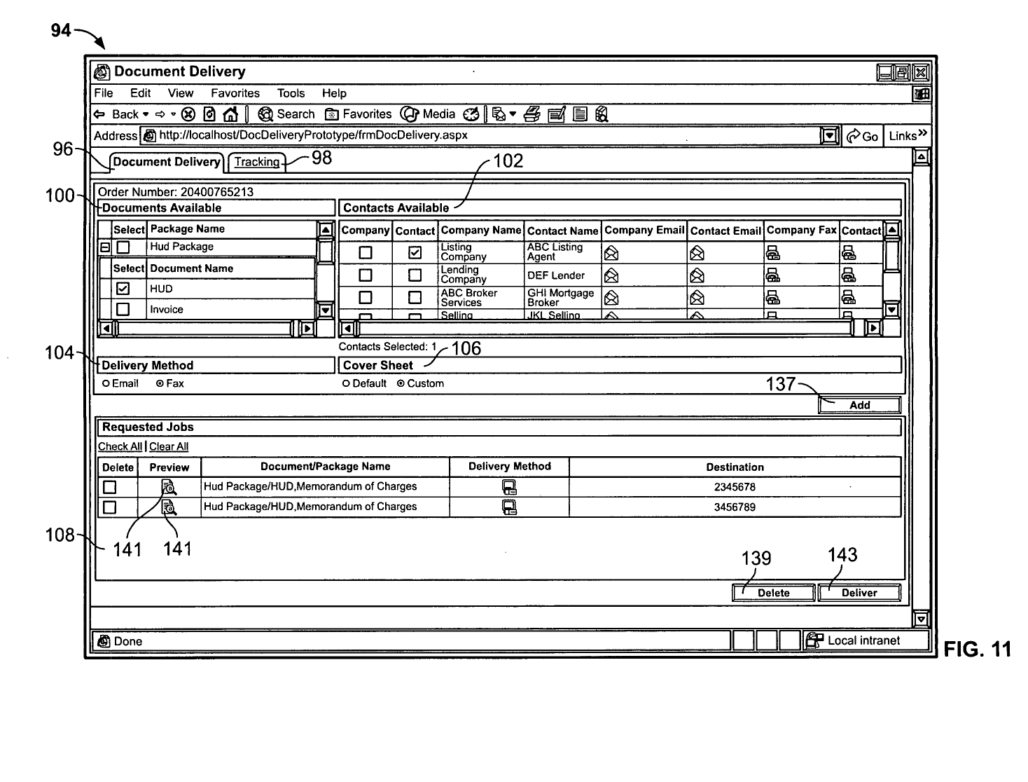

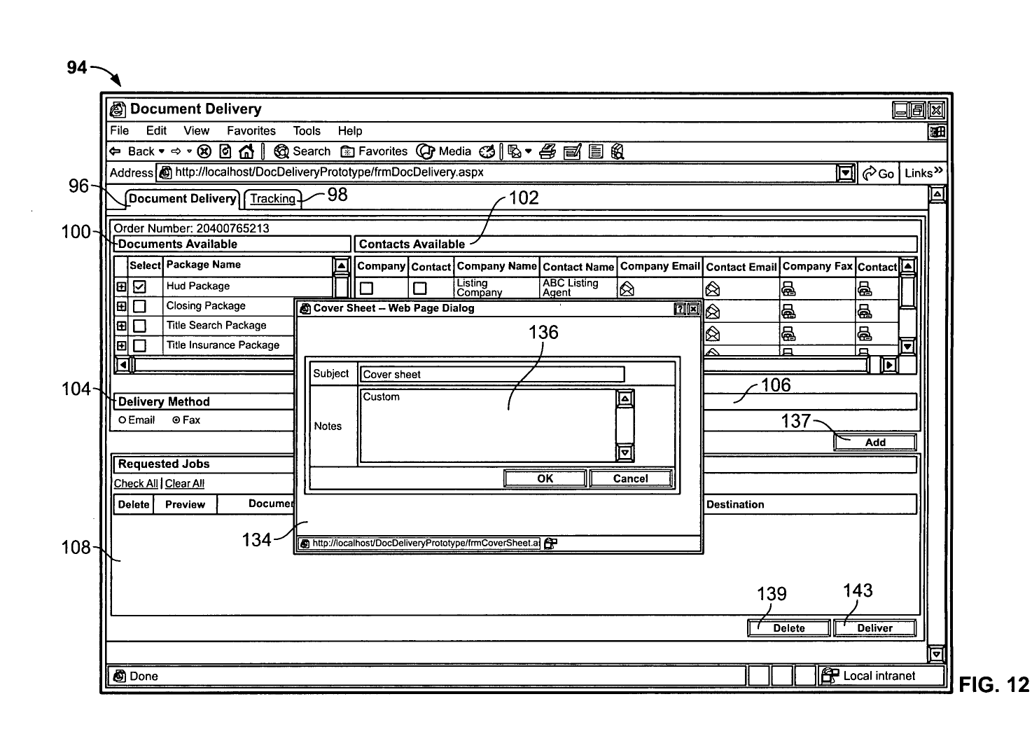

Referring to FIGS. 4A, 4B, 10, 11, and 12, in step 124, the control system 12 awaits selection of a cover sheet type by the user 50 with the cover sheet panel 106. For example, in step 126 and as shown in FIG. 10, the control system 12 receives an indication in the cover sheet panel 106 that the user 50 has selected a default cover sheet and, in step 128, the control system 12 appends a default cover sheet to the document information for communication by e-mail, fax, etc. In another example, in step 130 and as shown in FIG. 11, the control system 12 receives an indication from the UI that the user 50 has selected a custom cover sheet. From step 130, the communications method proceeds to step 132, where, as shown in FIG. 12, a window 134 opens for receiving cover sheet information from the user 50 into a data field 136. From steps 128 and 132, the communications method 82 proceeds to step 138.

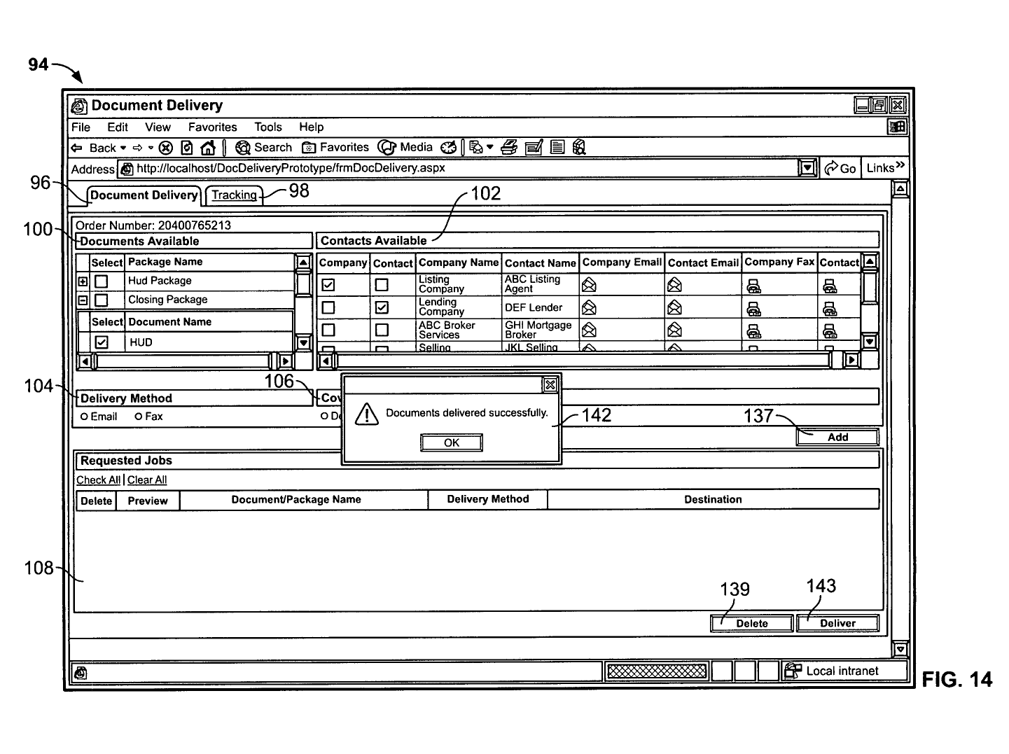

Referring to FIGS. 4B, 13, and 14, in step 138, the selected documents and destinations (recipients) are added to the request summary panel 108 in response to the user having selected the “Add” button 137. The user 50 is presented with an option of checking of boxes next to the selected documents and destination for deletion thereof by pressing a “Delete” button 139. The user 50 is presented with a selectable preview button 141 next to the selected documents and destination for previewing the total document package to be sent. In step 140, the user 50 presses a delivery button 143, and, as shown in FIG. 14, the control system 12 displays a window 142 to indicate that the documents have been “delivered successfully”, e.g., that the user request for delivery is being processed as herein described.

Referring to FIGS. 4B, 15, and 16, in step 142, a second interactive display, referenced herein as a tracking page 144, is shown in connection with the “Tracking” tab 98 having been actuated. The tracking page 144 includes an order status panel 146 and an order retrieval panel 148 that includes a date from field 151a, a date to field 151b, and a drop-down menu 150. The user 50 can search the status of previously-made user requests by specifying a range of time to be searched in the date from field 151a and the date to field 151b. As shown in FIG. 16, the user 50 can search the of previously made user-requests by actuating the drop-down menu 150 to select “requested”, “completed”, or “failed” deliveries as the search criteria.

The communications method 82 proceeds from step 142 to step 152, whereby the user 50 can tailor a search query. For example, in step 152 and as shown in FIG. 16, the user 50 can select to have a search return all requested deliveries that were requested between Oct. 1, 2006 and Oct. 4, 2006. The user 50 enters the dates in field 151a, 151b, selects “requested” from the drop-down menu 150, and actuates a “search” button 153. In step 154, the results of the search are displayed to the user 50 in the order status panel 146.

For each request returned as a result in step 154, the order status panel 146 preferably shows a name of that user which had made the request, the date on which the request was made, the document packages and/or documents thereof associated with the request, the identity of the party associated with the recipient system for the request, the delivery mode, e.g., the communications protocol of the recipient system, the “job status”, and a selection box for which the user 50 can select the request for re-delivery.

Regarding the printing of reports, in step 156, the user 50 can send the requests shown in the order status panel 146 to the queue at the application database server 26 by selecting the “print” button 157. In step 158, the report is printed on the printer 68, which is shown and designated in FIG. 2.

In step 160, the user 50 can resend previously made requests. For example, should a request have failed, the user 50 may choose to reattempt delivery by selecting the chosen selection boxes and actuating the “resend” button 161. A user might also choose to reattempt delivery of “requested” requests that are not yet “completed.” In step 162, a DocDelivery object, which is further discussed below, resends the job request to the application database server 26, and, in step 164, a failure notification is sent to the requester (the user 50) through e-mail with a copy of the selected documents and cover sheet.

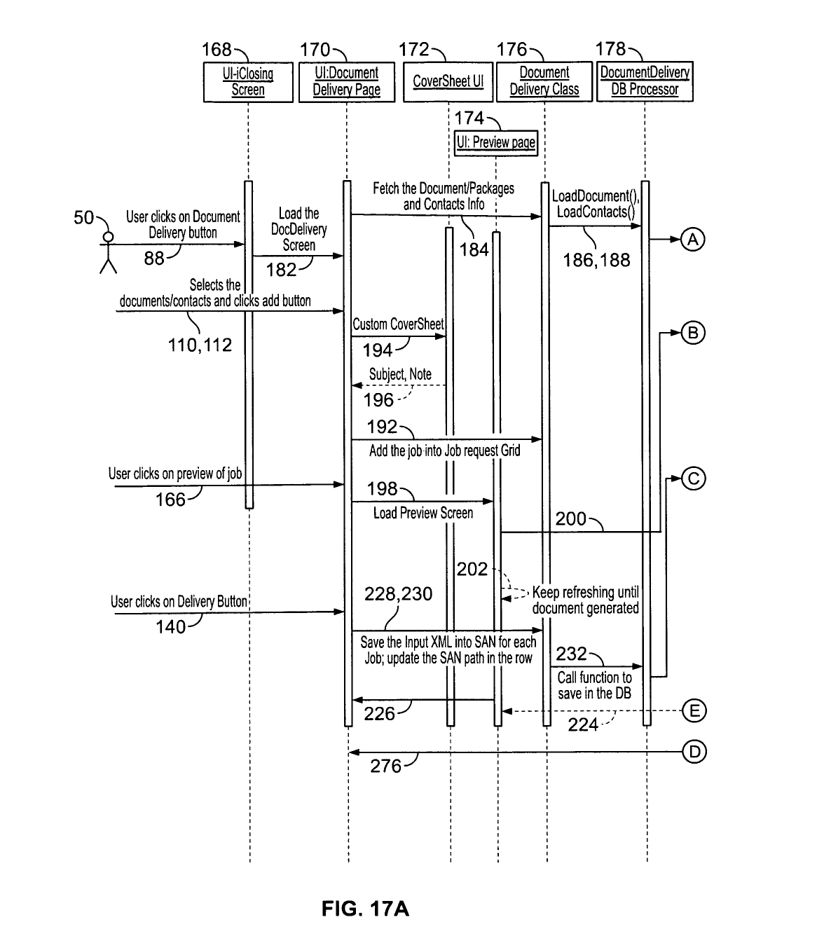

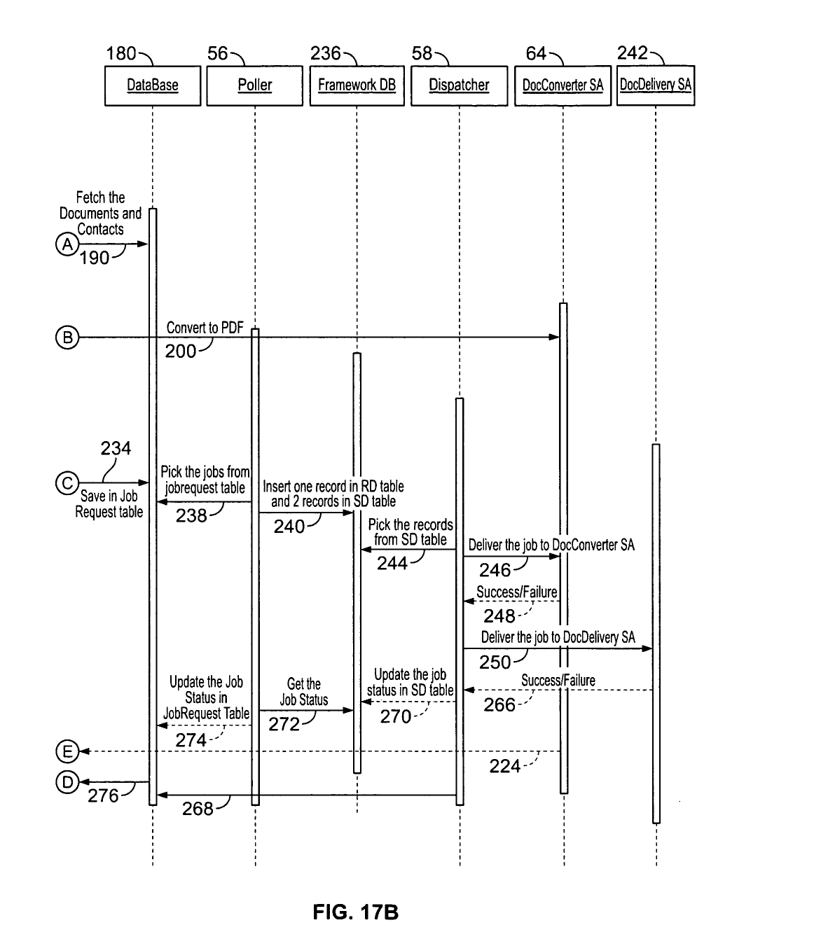

Referring to FIGS. 17A-21, the communications method 82 shall be discussed with further detail. In this regard, the software of the control system 12 is designed as a web-based solution using Microsoft's .Net framework. A layered software design pattern is adopted for functional segregation of components thereof. Exemplary layers include the graphical user interface layer (UI), an embodiment of which has been described above with reference to FIGS. 5-16, and for which a client browser, such as Microsoft Internet Explorer, acts as a container to the ASP.NET pages. The exemplary layers further include a server-side business layer that contains classes for implementing business logic, a server-side data layer that contains an abstraction data access layer for accessing databases resident on the application database sever 26, the framework database server 28, and/or elsewhere, and a server-side database layer having stored procedures (SP) executed from the data access layer.

Referring to FIGS. 17A and 17B, a message sequence diagram is shown illustrating the interactions between major software components of the control system 12. FIGS. 17A-B show four actions taken by the user 50, including, in step 88, launching the Document Delivery Page 94, in steps 110, 112, selecting document packages, documents thereof, and contacts, in step 166, previewing documents, and, in step 140, sending the document information. The four actions can be taken at a web-based application screen encapsulated by an UI:iClosing Screen object 168, which resides on the web servers 18 at the UI layer and which displays a link to a Document Delivery Page 94 encapsulated by a UI:Document Delivery Page object 170.

As indicated above, some embodiments of the present invention can be characterized as being an application-agnostic utility in which it is not required for launch to be initiated from an application. However, to facilitate consideration, discussion of an exemplary embodiment of the invention shall reference an application from which launch can take place, e.g., iClosings.

Upon clicking on the link in step 88, the Document Delivery Page 94 is displayed. The UI:Document Delivery Page object 170 is used to display and capture documents, the communications protocol for document information, e.g., e-mail, facsimile, etc., and destination addresses of contacts' recipient systems. The Document Delivery Page 94 produced by the UI:Document Delivery Page object 170 is written in ASP.NET (ASPX). The UI:Document Delivery Page object 170 resides on the web servers 18 in the UI layer and communicates with the middle-tier code on the mid-tier servers 20.

The UI:Document Delivery Page object 170 sends and receives messages directly or indirectly to/from other objects, including a CoverSheet UI Object 172, a UI: Preview Page object 174, a Document Delivery Class object 176, a Document Delivery DBProcessor object 178, a DataBase object 180, and a DocConverter SA object 64. Each of these objects shall be discussed with further detail below:
The CoverSheet UI Object 172 is used to display and capture the coversheet in the a cover sheet page for email and/or fax. The cover sheet page is written in ASP.NET (ASPX), and resides along with the CoverSheet UI Object 172 on the web servers 18 in the UI layer. As indicated above, the user 50 can control the control aspects of the coversheet using the coversheet panel 106.
The UI: Preview Page object 174 encapsulates the Preview Page for providing preview functionality. When the user 50 clicks on the preview button 141 in the Document Delivery Page 94, the UI: Preview Page object 174 makes a direct call (sends a message) to the DocConverter SA object 64 to create and display a PDF version of a selected document. The Preview Page is written in ASP.NET (ASPX), and resides along with the UI: Preview Page object 174 on the web servers 18 in the UI layer.
The Document Delivery Class object 176 bundles all required document information, a delivery method, a coversheet and other information into a Job Request XML document. The Document Delivery Class object 176 makes calls to (sends messages to) the DocumentDelivery DB Processor object 178. The Document Delivery Class object 176 is written in C#.NET and resides as part of mid-tier code on the mid-tier servers 20 in the business layer. A Windows 2003 Enterprise Edition platform with Visual Studio .Net 2003 is preferably used to write in C#.NET.
The Document Delivery DBProcessor object 178 is responsible for saving job request information into the primary queue, e.g., a job request table, in the application database 54 at the server 26 therefore. The Document Delivery DBProcessor object 178 resides as part of mid-tier code on the mid-tier servers 20 in the data layer and is written in C#.NET.
The DocConverter SA object 64 converts word documents, images, reports, ASP/ASP.NET Pages, etc. into PDF format using client-side emulation on the server side. The DocConverter SA object 64 gets called by the UI: Preview Page object 174 to convert a document to be previewed on the Preview Page into PDF format. The DocConverter SA object 64 runs on the framework servers 22 in the business layer and is written in C#.NET. The DocConverter SA object 64 runs within the process and memory space of the Dispatcher object 58.

Continuing with reference to FIG. 17A, after the user 50 clicks on the Document Delivery button 143 in step 88 at the iClosing Screen, the iClosings Object 168 sends the “Load the DocDeliver Screen” message 182 to the UI:Document Delivery Page object 170. After loading the Document Delivery Page 94, the UI:Document Delivery Page object 170 sends a message 184 to the Document Delivery Class 176 to fetch one or more documents/packages and contact information. The Document Delivery Class 176 sends a LoadDocuments and LoadContacts message 186, 188 to the DocumentDelivery DBProcessor object 178. The DocumentDelivery DBProcessor object 178 sends a “Fetch the Documents and Contacts” message 190 to the DataBase object 180 for communication with the application database 54. The DataBase object 180 retrieves the names of the requested documents and contacts along with any data associated with same, and returns strings representative of the documents and contacts back through the chain of the aforementioned objects so that the requested documents and contact information is displayed on the Document Delivery Page 94 via the UI:Document Delivery Page object 170.

The user 50 clicks on entries in the Document Delivery Page 94 to select the desired documents and contacts and clicks on the “ADD” button 137. This causes the UI:Document Delivery Page object 170 to call a Proc_LoadDocuments( ) stored procedure to fetch all relevant documents against an Order Number, and a Proc_LoadContacts( ) stored procedure to fetch contact information. These stored procedures are retrieved from the application database 54. The Proc_LoadDocuments( ) stored procedure obtain document information, the roles and rights associated with the document information, and related image data.

The Proc_LoadDocuments( ) stored procedure loops through the record set and does a File.Exists( ) for each word document. All the images and web pages returned by the SP are preferably available for display in the request summary panel 108. For a document package, all the documents for the package preferably loaded into the request summary panel 108, but check boxes are disabled for those documents that do not exist for the corresponding order number. If a document is not created for an order number, the name of the document is not loaded in the request summary panel 108 unless it is a part of the document package where the check box for that document will be disabled. For example, say the SP returns
Package 1
   Doc 1
   Doc 2
   Doc 3
   Doc 4
   Web Page 1
Package 2
   Doc 2
   Doc 4
   Web page 2
Package 3
   Doc 5
   Doc 2
   Doc 7
Doc 1
Doc 2
Doc 3
Doc 4
Doc 5
Doc 6
Doc 7
Web Page 1
Web Page 2
Image 1
Image 2
Image 3
   Now say, for this particular order Doc 3 and Doc 4 does not exist or is not yet created. Then the request summary panel 108 would include the following:
Package 1
   Doc 1
   Doc 2
   Doc 3 (check box disabled)
   Doc 4 (check box disabled)
   Web Page 1
Package 2
   Doc 2
   Doc 4 (check box disabled)
   Web page 2
Package 3
   Doc 5
   Doc 2
   Doc 7
Doc 1
Doc 2
Doc 5
Doc 6
Doc 7
Web Page 1
Web Page 2
Image 1
Image 2
Image 3

Continuing with reference to FIG. 17A, the message 110 indicating that contact selections have been made is sent to the UI:Document Delivery Page object 170. The UI:Document Delivery Page object 170 sends a message 192 to the Document Delivery Class Object 176 to “add jobs to the request grid” indicative of the document/contact pairs being “added” to the request summary panel 108, and the Document Delivery Class Object 176 creates a Job Request XML.

The user 50 can select the custom button in the cover sheet panel 106 if a document is to be sent to a recipient system with a custom FAX cover page. If the user 50 had selected the custom cover sheet button, then a message 194 is sent to the CoverSheet UI Object 172 to provide a custom cover sheet. The CoverSheet UI Object 172 calls the Proc_getCoverSheetInfo( ) stored procedure. The Proc_getCoverSheetInfo( ) stored procedure returns cover sheet details. In pseudo code:
If Coversheettype is Email, select template path, subject=default subject if custom subject is null else custom subject, message=default message if custom message is null else custom message for the given business unit id and cover sheet type from a coversheet table.
If Coversheettype is FAX, select template path, subject=default subject if custom subject is null else custom subject, message=default message if custom message is null else custom message for the given business unit id and cover sheet type from the coversheet table.

The CoverSheet UI Object 172 returns a string containing the “Subject: and Note:” headings are returned to the user screen via the UI:Document Delivery Page object 170. The user 50 enters strings corresponding to the “Subject:” and “Note:” prompts previously returned. These strings are returned at step 196 to the UI:Document Delivery Page object 170 and associated with the appropriate document/contact pairs of the job requests.

The UI:Document Delivery Page object 170 prepares a Request XML. The Request XML preferably includes information regarding the selected documents and/or web pages and/or images, cover sheet information, recipient system (contact) information, user information, order and business unit information and the communications protocol, e.g., fax delivery, e-mail delivery, etc. Then the UI:Document Delivery Page object 170 stores the request as Request XML in a hidden column of the request summary panel 108. The request summary panel 108 is loaded with custom package name, contact information, and the delivery method. The custom package name is preferably a maximum of thirty characters. The first twenty-seven characters are preferably built from the selected document packages and/or documents therefore, e.g., a commitment document, a closing document, a HUD document, etc. The last three characters are preferably dots. If the package name is within twenty-seven characters, it is preferable for no dots to be displayed. As shown in FIGS. 9 and 10, the user 50 can click on the “+” character to view the documents of the document package. The order in which the documents are shown should preferably follow the order in which the documents were selected. The user 50 can click the check boxes of the job(s) and click the Delete button 139 to delete the jobs from the request summary panel 108. It is contemplated that the user 50 can be provided with an option to check or clear all check boxes simultaneously.

The User 50 may desire to preview each document before delivering same to a destination. In order to preview a document, the documents is first converted to PDF format and returned in this form to the user 50. The user 50 invokes the “preview of job” message of the UI:Document Delivery Page object 170 by selecting one of the preview buttons 141. The UI:Document Delivery Page object 170 in turn sends a “Load Preview Screen” message 198 to the UI: Preview Page object 174. The UI: Preview Page object 174 maintains three session variables:

CreatedFile—stores the file path of the final PDF file.

InProcess—string denoting the status of a worker thread.

Error—string denoting the error message during thread execution.

The UI: Preview Page object 174 executes the following pseudo code:

```
  If (session (”createdfile”) does not exist)
  {
    session(“createdfile”) = “”;
    start a thread passing HttpContext and the RequestXML;
  }
  if (session (”createdfile”) == “”)
  {
    Display processing image; This image can be a progress bar or
an applet in Javascript;
    Set Refresh time of the page;
    Return;
  }
  if(session(“error”) != “”)
  {
    Show a error message to the user.
  }
  if(session(“created file”) != “” and session(“error”) == “”)
  {
    Read the PDF file;
    Set the content type of the page to PDF;
    Stream the page out using Response.Stream Object;
    Delete the previous PDF file;
    Remove session variables;
  }
```

The execution of the thread creates a singleton object to asynchronously create a PDF, and, using HTTPContext, reads posted request data and builds the DocConverter request XML. The execution of the thread calls the DocConverter SA object 64 passing XML and output file path. The execution thread waits until the PDF is created and the thread uses HTTPContext/Session to set a created file session variable to the output file name. The thread returns, and, if there is any error during processing, sets an error session variable to identify same.

During the execution of the created thread, the UI: Preview Page object 174 sends a “Convert to PDF” message 200 to the DocConverter SA object 64 with a reference to the documents to be converted. In step 202, the UI: Preview Page object 174 goes into a refresh loop waiting for the PDF document to be returned.

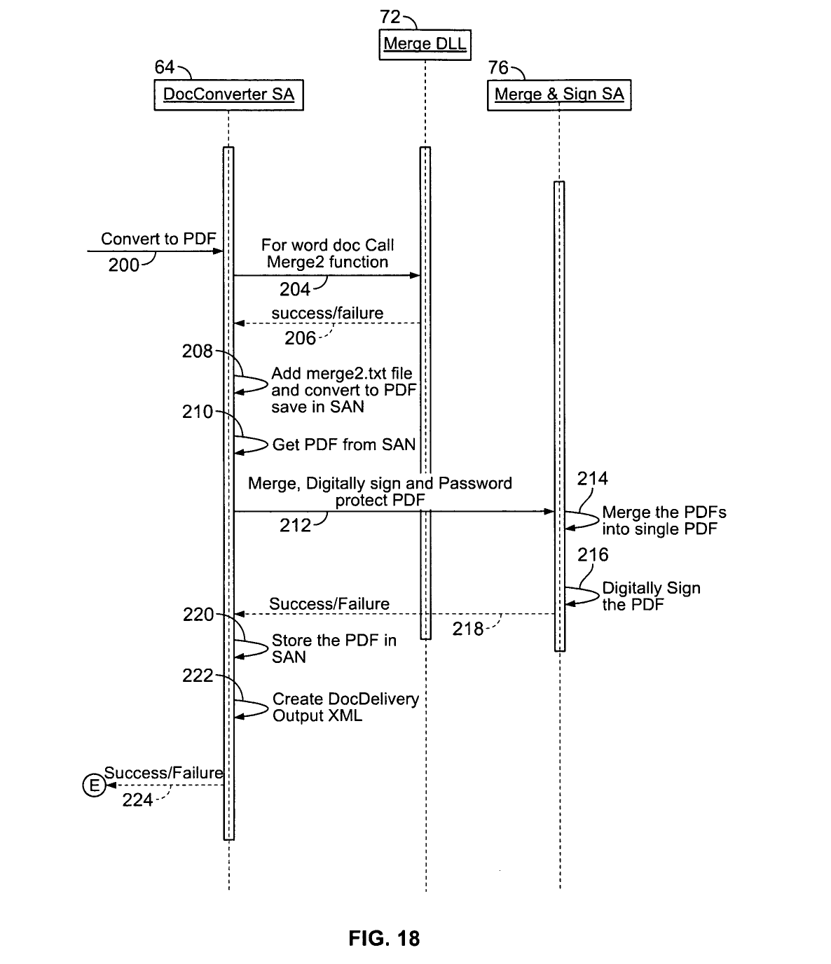

Referring to FIG. 18, the DocConverter SA object 64 shall be discussed with further detail. More particularly, the message sequence diagram of FIG. 18 depicts interactions between objects involved in producing a PDF version of a document, which includes the DocConverter SA object 64, the Merge DLL SA object 72, and the Merge & Sign SA object 76.

The job of the Merge DLL SA object 72 is to get data from the application database 54 via the DataBase object 180 that can be merged with, for example, a Word Document. The Merge DLL SA object 72 communicates with the application database 54 and creates a MERGE.TXT file on the SAN. The MERGE.TXT file is later used to merge the data into, for example, a Word Document. The Merge DLL SA object 72 runs on the framework servers 22 in the business layer and is written in C#.NET. The Merge & Sign SA object 76 merges multiple converted PDF files preferably into one PDF file. Based on incoming XML values, the Merge & Sign SA object 76 can additionally provide functionality to digitally sign and encrypt the merged file. The Merge & Sign SA object 76 runs on the framework servers 22 in the business layer and is written in C#.NET. The Merge & Sign SA object 76 also runs within the process and memory space of Dispatcher object 58.

The DocConverter SA object 64 parses the Request XML after having received the “Convert to PDF” message 200. The DocConverter SA object 64 converts a cover letter into HTML and retrieves the desired document files from the SAN into temporary buffers. The DocConverter SA object 64 forwards references to separate buffers and calls the Merge2 function 204 of the Merge DLL SA object 72. The Merge DLL SA object 72 connects to the application database 54 of the server 26 therefore, retrieves the document information to merge, and sends a SUCCESS/FAILURE message 206 back to the DocConverter SA object 64. If the returned message 206 is SUCCESS, then the DocConverter SA object 64 sends a message 208 to itself to add a merge2.txt file, convert the file into PDF, and save the converted file to the SAN. In step 210, the saved file fragment in PDF format is retrieved from the SAN.

The DocConverter SA object 64 sends a “Merge, Digitally Sign, and Password protect PDF” message 212 to the Merge & Sign SA object 76 along with a reference to a buffer containing the PDF fragment to be merged into a complete PDF document. Messages/Steps 204-212 are repeated for each document fragment until all fragments are assembled into a complete document. The Merge & Sign SA object 76 sends a message 214 to itself to merge the PDF fragments into a single document, and, in step 216, the Merge & Sign SA object 76 digitally signs the PDF file. In step 218, Merge & Sign SA object 76 returns a completion code and a reference to a buffer containing the complete PDF document to the DocConverter SA object 64. In step 220, the DocConverter SA object 64 stores the completed PDF document buffer in the SAN. The Merge & Sign SA object 76 preferably utilizes Aspose Word Version 2.7 software.

In step 222, the DocConverter SA object 64 creates DocDelivery Output XML containing a job type, file path(s) of the PDF(s) to be delivered, and cover sheet details. If the recipient system is a fax recipient system, the merged PDF will include, as the first document thereof, the cover sheet document, which is followed by the other documents. In the case of a facsimile recipient system, preferably one PDF document file path is in the XML. In the case of an email recipient system, the first document in an array of file paths is a cover letter HTML document followed by the PDFs. The DocConverter SA object 64 returns a completion code message 224 to the UI: Preview Page object 174 shown in FIG. 17A.

Referring to FIGS. 17A and 17B, the UI: Preview Page object 174 retrieves the completed PDF file from the SAN, inserts the completed PDF file into an XML document, and, in step 226, returns the XML document to the UI:Document Delivery Page object 170. The UI:Document Delivery Page object 170 displays the PDF file to the user 50 at the corresponding one of the client systems 14.

After previewing the PDF version of the document, the user 50 may wish to preview other documents. In such circumstances, the steps associated with the UI: Preview Page object 174 can be repeated for each document. After previewing all the desired documents, the user 50 may wish to send one or more of these documents to the recipient systems 16 of one or more of the desired contacts presented on the Document Delivery Page 94. For each document/contact pair checked on the Document Delivery Page 94, the following sequence of messages are sent between objects:

In step 140, the user 50 clicks on the Deliver button 143 in the Document Delivery Page 94 to deliver all the jobs present in the request summary panel 108, which sends a corresponding message to the UI:Document Delivery Page object 170. For each document/contact pair, an associated XML document is generated with a reference to the document to be delivered. Each requested job is a associated with a row in the request summary panel 108. The UI:Document Delivery Page object 170 loops through the requests, saves the request XMLs in the SAN, and builds a string of file paths.

The UI:Document Delivery Page object 170 calls the Proc_RequestBulkJobs( ) stored procedures that do the bulk insert into the primary queue, e.g., a job request table, in the application database 54 of the server 26 therefore. The pseudo code of Proc_InsertBulkJobs (sOrdRef, idUsr, comma separated strings of file paths, comma separated strings of jobtypeid) can be characterized as follows:
For the given order number, loop through the comma separated list of FILE paths and the JobTypeIDs and insert into JobRequest table.
Each requested job will have a pending status.

In this regard, it is contemplated that XML can be sent to the stored procedure of TEXT datatype, rather than having commas separated strings. In Proc_InsertBulkJobs( ), the UI:Document Delivery Page object 170 sends to the Document Delivery Class object 176 a “Save the XML message into SAN” message 228 (with a reference to the generated XML document), as well as a “Update the SAN [file] path in the row” message 230.

The Document Delivery Class object 176 sends a message 232 to the Document Delivery DBProcessor object 178 to save the referenced XML document in the application database 54 of the server 26 therefore. The Document Delivery DBProcessor object 178 sends a “Save in JobRequest table” message 234 to the Database Object 180, which saves the XML document along with job identification information referencing the document/contact pair in the primary queue, e.g., the job request table.

Referring to FIG. 17B, the Poller object 56 shall now be discussed with further detail. The Poller object 56 communicates with the DataBase object 180, a Framework DB object 236, and the Dispatcher object 58. The Poller object 56 is preferably a multi-threaded windows service which polls the application database 54 (via the DataBase object 180) for Job Requests in the primary queue, e.g., the job request table. The Poller object 56 also polls the framework database 60 (via the Framework DB object 236) to identify completed or failed requests. The control system 12 can include a plurality of application databases 54, each sharing the Poller object 56 and/or DataBase object 180 or having a dedicated Poller object and a dedicated DataBase object corresponding thereto. As shown in FIG. 3, the Poller object 56 includes a Database Listener, which runs in a continuous loop to identify when a job request is to be released from the primary queue. The Poller object 56 further includes a Framework Listener, which runs in a continuous loop to identify from a secondary queue in the framework database 60 when a service request has been completed.

The Poller object 56 preferably continuously polls the DataBase object 180 to find job requests, e.g., documents information to be delivered to the recipient systems 16 of contacts. The Poller object 56 calls the Proc_GetDocDeliveryDetails( ) stored procedure, which polls the primary queue, e.g., the job request table, and prepares XML for the Poller Request. This XML preferably includes thesOrdRef, User details, Request XML FILE Path and the Job type. The XML also updates the Job Status of the request to “Processing”. Based on the Request Config of the Poller object 56, the Poller object 56 will place entries in a secondary queue in the framework database 60, which preferably includes a Request Details (RD) table and a Service Detail (SD) table, which shall each be described with further detail below.

The Poller object 56 sends a “Pick the Jobs from the JobRequest Table” message 238 to the DataBase object 180. After retrieving an outstanding job request from the DataBase object 180, the Poller object 56 sends a message 240 to the Framework DB object 236 to inserts in the framework database 60 a record of the job in the RD table and two records of service requests in the SD table (one for the DocConverter SA Object 64 and one for a DocDelivery SA Object 242). The Poller object 56 shall be discussed with further detail below.

Continuing with reference to FIG. 17B, the Dispatcher object 58 is a multi-threaded Windows service that contains classes to retrieve service requests from the framework database 60 (via the Framework DB object 236), add the service requests to a tertiary queue, and assign a thread to execute each service agent. The Dispatcher object 58 dispatches a request based on the task information in the framework database 60. The Dispatcher object 58 has intelligence to determine which service agent is appropriate to handle a given task. The service agents can run as a physically local service to the Dispatcher object 58 and/or as a remote service on a remote server, and the Dispatcher object 58 can call either of such types of service agents. The Dispatcher object 58 can be load-balanced as well as scaled horizontally and/or vertically. The Dispatcher object 58 provides recovery logic and purges the framework database 60 for old service requests. For example, the Dispatcher object 58 automatically recovers and retries any failed jobs. Intelligence is built into the Dispatcher object 58 such that, based on an error type and/or error message, the dispatcher object can recover and retry a failed job and/or cause a job to fail if the job cannot succeed.

The Dispatcher object 58 retrieves the RD record and SD records associated with a job request. The Dispatcher object 58 sends the request to the DocConverter SA Object 64, gets the output PDF path(s), and then dispatches the request to the DocDelivery SA Object 242 to deliver the PDF. More particularly, if there is an outstanding request to send a document, the Dispatcher object 58 sends a message 244 to the Framework DB object 236 to pick a job record from the SD table stored in the framework database 60. The Framework DB object 236 returns a job record to the Dispatcher object 58.

The Dispatcher object 58 sends a reference to a document to be delivered in a message 246 to the DocConverter SA Object 64, which delivers the “job” to the DocConverter SA Object 64. The DocConverter SA Object 64 repeats steps similar to these described above in connection with merging documents and convert a completed document to PDF format. It is preferably to utilize ActivePDF PDF 1.3 Service Pack 7 in connection with the conversion to PDF format. After the conversion to PDF format has been completed, the DocConverter SA Object 64 sends a status message 248 to the Dispatcher object 58 indicating SUCCESS or FAILURE of the conversion. If the conversion is successful, the Dispatcher object 58 sends a message 250 to the DocDelivery SA Object 242 for delivery of an attached PDF document to a desired contact.

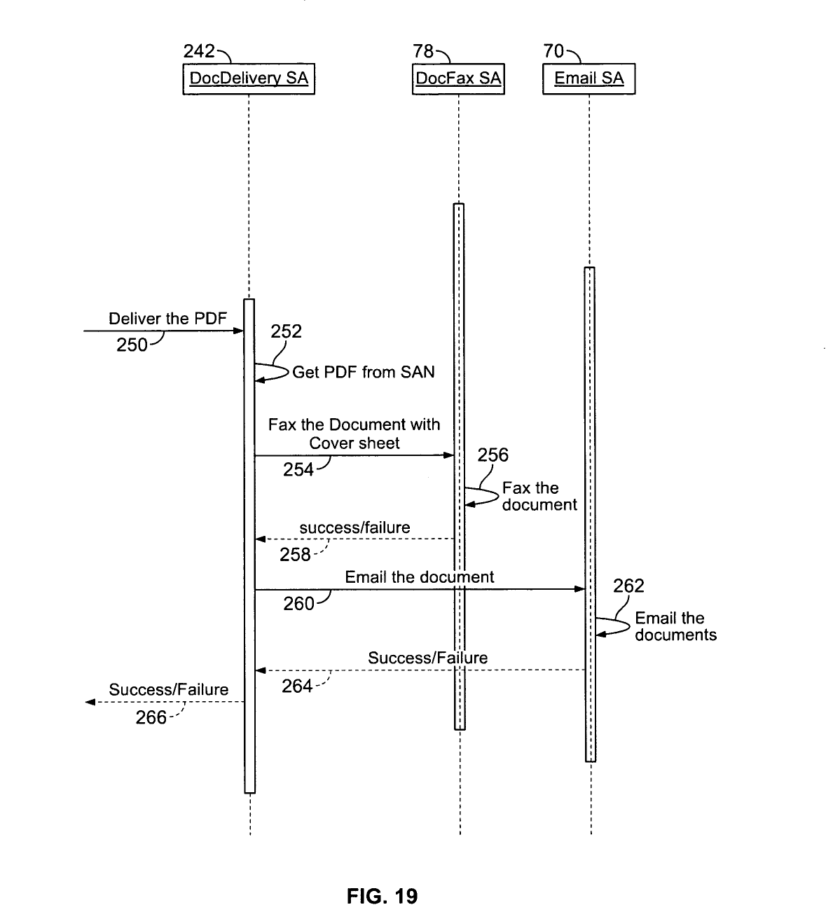

Referring to FIG. 19, the DocDelivery SA object 242 shall be discussed with further detail. More particularly, a message sequence diagram is depicted showing the interactions between objects involved in sending a PDF version of a document to one of the recipient systems 16 associated with a desired contact. In this regard, after receiving the message 250 to deliver a PDF version of a desired document, the DocDelivery SA object 242 sends the document to an SA-type object to deliver the document in a form suitable for a given recipient system, e.g., fax, e-mail, etc.

The DocDelivery SA object 242 parses the Request XML, gets the PDF documents(s) from the SAN, then communicates with, in the case of a fax recipient system 38, the DocFax SA object 78 for delivering document information to a contact associated with a FAX machine. In the case of an e-mail recipient system 40, the DocDelivery SA object 242 communicates with an Email SA object 70 for delivering document information via E-mail to a contact associated with a desktop computer system, a handheld communications device, etc.

The role of the DocFax SA object 78 is to fax a PDF version of a document passed to it. The DocFax SA object 78 uses the RightFax Application Programming Interface (API) to convert and stream a document in PDF format to RightFax format. The DocFax SA object 78 communicates with the fax server 30, which is preferably a RightFax server and sends the document via a communications protocol suitable for facsimile communications. The DocFax SA object 78 is written in C#.NET. The DocFax SA object 78 runs on the framework servers 22 within the process and memory space of the Dispatcher object 58.

The role of the Email SA object 70 is to email a PDF version of a document passed to it with the cover sheet. The Email SA object 70 internally uses the C# Email Application Programming Interface (API) to attach the coversheet as the body of the Email and attach the document information as an attachment to the email. The Email SA object 70 communicates with the e-mail server 32 to send the document to an e-mail recipient system. The Email SA object 70 runs on the framework servers 22 within the process and memory space of the Dispatcher object 58. The Email SA object 70 is written in C#.NET.

Continuing with reference to FIG. 19, the DocDelivery SA Object 242 retrieves the desired document referenced in the message 250 from the SAN via a message 252. If the document is to be delivered to the fax recipient system 38, the DocDelivery SA Object 242 sends a “Fax the Document with Cover Sheet” message 254 to the DocFax SA object 78 with the PDF document (and cover sheet retrieved from the input XML). The DocFax SA object 78 converts the PDF document to RightFax format and faxes the document via message 256 to the fax recipient system. The DocFax SA object 78 returns a status message 258 of SUCCESS/FAILURE to the DocDelivery SA Object 242.

If the document is to be delivered to the e-mail recipient system 40, the DocDelivery SA Object 242 sends an “Email the Document” message 260 to the Email SA object 70 in XML, containing a To: heading, a Subject: heading, a cover sheet, and a PDF file path. The Email SA object 70 attaches the PDF document based on its file path and e-mails the document via message 262 to the e-mail recipient system 40. The Email SA object 70 returns a status message 264 of SUCCESS/FAILURE to the DocDelivery SA Object 242.

Referring to FIGS. 17B and 19, the status message 258, 264 are relayed via message 266 to the Dispatcher object 58 to indicate SUCCESS/FAILURE. The Dispatcher object 58 sends a message 268 to the DataBase Object 180 to update the status of the DocDelivery SA Object 242 in the application database 180, e.g., to communicate available dispatching capacity. The Dispatcher object 58 saves the results into the framework database 60 (via the Framework DB object 236) and from message 270, which update the job status in the SD table of the secondary queue.

The Poller object 56 repeatedly polls the Dispatcher object 58 via a “Get the Job Status” message 272 to determine whether a desired document was sent to a desired contact via the DocDelivery SA object 242. The Poller object 56 sends a message 274 updating the status of a pending job in the primary queue, e.g., the job request table, via the DataBase object 180. A message 276 is sent to the UI:Document Delivery Page object 170 indicating the status of the job request, which causes a message (Success/Failure) to displayed on the tracking page 144 when such is activated by the user 50.

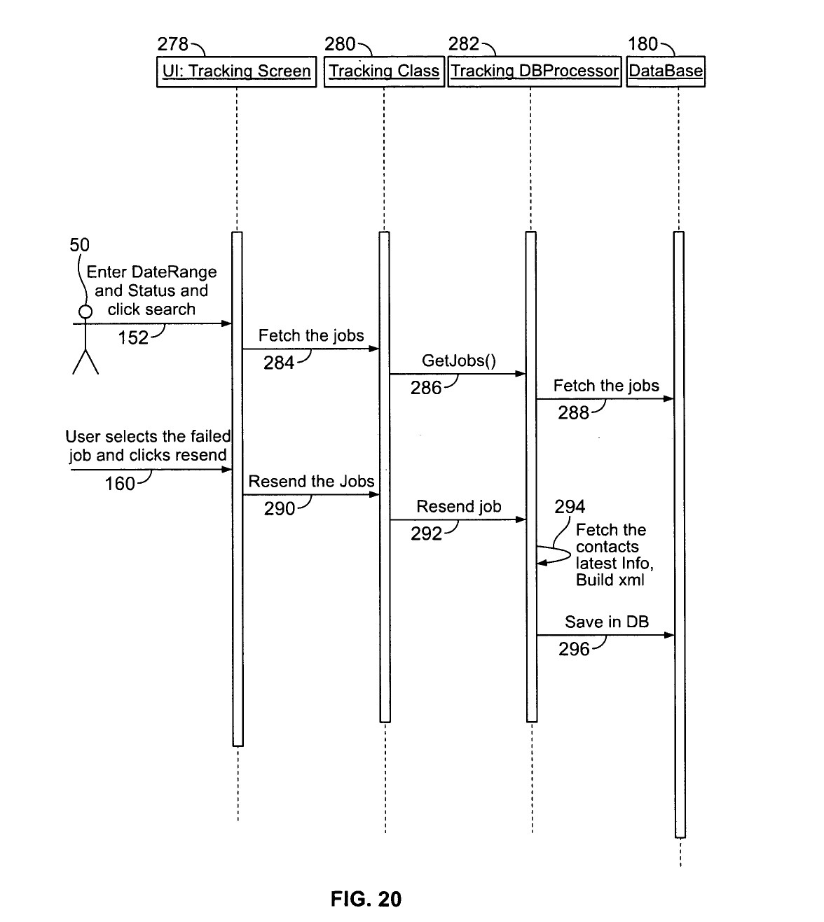

Referring to FIG. 20, the tracking of messages shall now be discussed with further detail. This message sequence diagram provides the functionality between the user 50 and the tracking page 144 presented to the user 50 by a UI: Tracking Screen object 278. Other objects with which the Tracking Screen object 278 interacts include a Tracking Class Object 280, a TrackingDBProcessor object 282, and the DataBase object 180 previously described.

The Tracking screen 114 is encapsulated in the UI: Tracking Screen object 2788, which displays all delivered jobs with a status field indicating “Completed” (success), “Failed” (failure), or “Requested” (in progress). The UI: Tracking Screen object 278 communicates with the Tracking Class object 280 in code written in ASP.NET (ASPX) and resident on the web servers 18 in the UI Layer. The Tracking Class Object 280 is responsible for querying the application database 54 via the DataBase object 180 for all delivered jobs and their statuses via the Tracking DB Processor object 282. The Tracking Class Object 278 is written in C#.NET and resides as part of mid-tier code on the mid-tier servers 20 in the business layer. The TrackingDBProcessor object 282 is responsible for connecting to the database 54, querying the database 54 for all delivered jobs and their statuses. The TrackingDBProcessor object 282 is written in C#.NET and resides as part of mid-tier code on the mid-tier servers 20 in the data layer.

Referring to FIGS. 4B, 15, 16, and 20, the user 50 can track the status of each job (document/contact pair) in the tracking page 144. When the user 50 clicks the Tracking tab 98 of FIGS. 15 and 16, all jobs requested for that order are shown in the order status panel 146. As shown in FIGS. 4B, 15, 16, and 20, in step 152, these jobs are searchable using the date from field 151a, the date to field 151b, and the drop-down menu 150. In response to selection of the search button 153, the UI: Tracking Screen object 278 calls the Proc_GetRequestedJobs( ) stored procedure to load the order status panel 146. The Pseudo code of Proc_GetRequestedJobs (sOrdRef, idUsr, dtfrom optional, dtTo optional, JobStatusID optional) is as follows:
For the given order number, select the jobs that satisfy the passed criteria.
   For each job returned by Proc_GetRequestedJobs( ), do the following:
Get the Request XML from the SAN by the file path;
Parse the Request XML and load the order status panel 146; and
load the JobRequestID, Job Status, and the Failure Description if failed in the order status panel 146.

In this regard, UI: Tracking Screen object 278 sends a “Fetch the jobs” message 284 to the Tracking Class object 280. The Tracking Class object 280, in turn, invokes a GetJobs( ) method 286 of the TrackingDBProcessor Object 282. The TrackingDBProcessor Object 282 sends a “Fetch the Jobs” message 288 to the DataBase object 180. The DataBase object 180 selects the desired message/contact pairs and status and returns the data back through the chain of objects to the user interface Tracking Screen Object 278 which formats the data on for the order status panel 146 of the tracking page 144.

The user 50 can select one or multiple jobs whose status has failed in step 160 and then click the resend button 161 on the tracking page 144. The Tracking Screen object 278 will do the following when the resend button 161 is clicked. For each job selected to resend, the request XML is parsed and the Delivery method, CustomerID and CustomerType are found. The UI: Tracking Screen object 278 calls the Proc_GetLatestContactInfo( ) stored procedures for obtaining the latest contact information from the application database 54 for a customer. The Pseudo code of Proc_GetLatestContactInfo (OrderID, CustomerID, CustomerType, DeliveryMethod, LatestContactInfo out) is
If the DeliveryMethod is Email and CustomerType is “Customer”, pull the Email ID of this customer from the Cust table and store it in LatestContactInfo.
If the DeliveryMethod is FAX and CustomerType is “Customer”, pull the FAX number of this customer from the Cust table and store it in LatestContactInfo.
If the DeliveryMethod is Email and CustomerType is “Owner”, pull the Email ID of this owner from the Owner table and store it in LatestContactInfo.
If the DeliveryMethod is FAX and CustomerType is “Owner”, pull the FAX number of this owner from the Owner table and store it in LatestContactInfo.
Save the request XML in the SAN and store the OrderID, FILE path and the JobType ID in a Datatable.
Call Proc_RequestBulkJobs( ) for all the rows in the datatable.

Referring to FIGS. 4B and 20, in step 162, the UI: Tracking Screen object 278, sends a “resend the jobs” message 290 to the Tracking Class object 280 along with a list of documents/contacts, and the Tracking Class Object 280, in turn sends a “resend job” message 292 to the TrackingDBProcessor Object 282 for each document/contact pair. The Tracking DBProcessor Object 282 fetches the latest contact information in step 294 of FIG. 20. In step 296, the Tracking DBProcessor Object 282 save the job in the primary queue, e.g., the job table, of the application database 54 via the DataBase Object 180. The Poller object 56, the Dispatcher object 58, etc. then act upon the saved, resent request as if said request is an initial request.

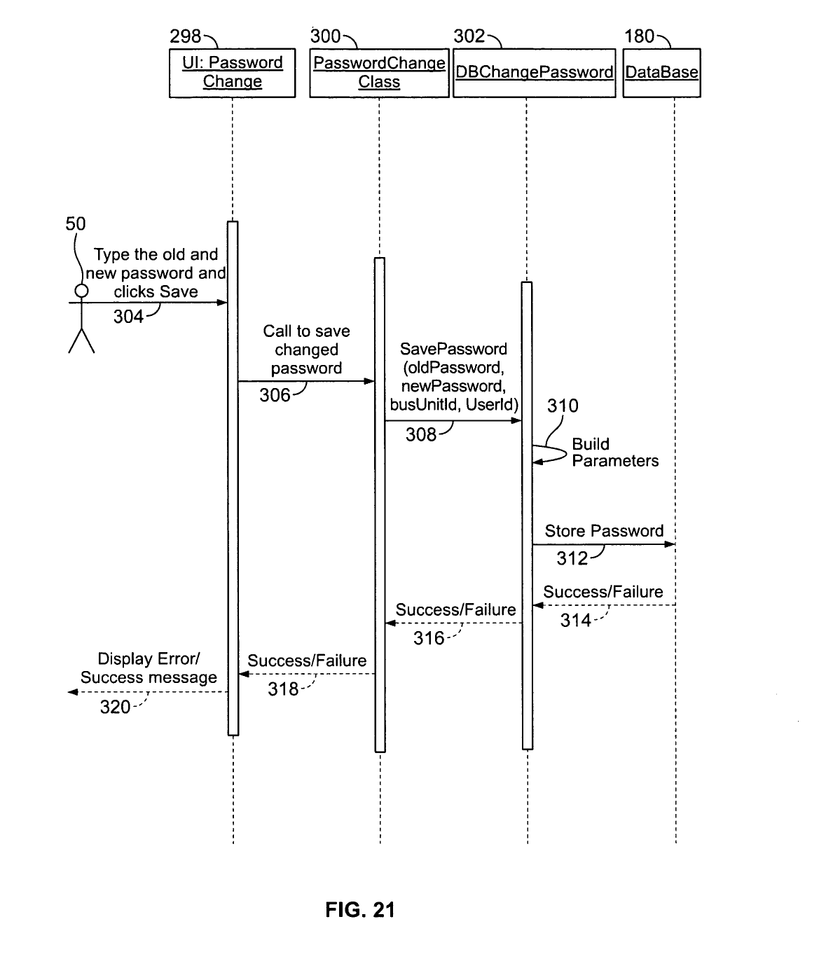

Referring to FIG. 21, exemplary embodiments of the control system 12 and communications method 82 provide documents with password protection, and a message sequence diagram shows the functionality between the user 50 and a Password Change Screen (not shown) presented to the user 50 by a user interface UI: Password Change object 298. The other objects with which the UI: Password Change object 298 interacts include a Password Change Class object 300, a DBChangePassword object 302, and the DataBase object 180 previously described.

The UI: Password Change object 298 encapsulates the functionality of the Password Change Screen for displaying the current (or default) password, entering a new password, and changing the current (or default) password to the new password (the password is used to encrypt PDF files). The UI: Password Change object 298 is written in ASP.NET (ASPX), and resides on the web servers 18 in the UI layer. The Password Change Class object 300 is responsible for querying the application database 54 via the DataBase object 180 for the current (or default) password. The Password Change Class Object 300 communicates with the DataBase object 180 via the DBChangePassword object 302. The Password Change Class Object 300 is written in C#.NET and resides as part of mid-tier code on the mid-tier servers 20 in the business layer.

The DBChangePassword object 302 is responsible for communicating with the application database 54 (via the DataBase object 180), querying the database 54 for the current (or default) password and changing same to the new password. The DBChangePassword object 302 is written in C#.NET, and resides as part of mid-tier code on the mid-tier servers 20 in the data layer.

To change a password, the user 50, in step 304, enters the current (or default) and new passwords and then clicks “Save” on the Password Change Screen. In response, the UI: Password Change object 298 sends a “save changed password” message 306 to the Password Change Class object 300. The Password Change Class Object 300, in turn, invokes a SavePassword( ) method 308 of the DBChangePassword object 302. The DBChangePassword object 564 builds parameters 310 for containing the new password and invokes an ExecuteSQL( ) method 312 at the DataBase object 180 to store the new password. The DataBase object 180 sets a status field and returns SUCCESS/FAILURE which is passed through the various objects through similar status fields in the messages 314, 316, and 318 to the UI: Password Change object 298, which formats an ERROR/SUCCESS message 320 for display on the Password Change Screen.

The present invention is subject to modifications and variations. For example, the present invention is not limited to service agents 62 for fax and e-Mail. The present invention can be adapted to other types of document transfer methods, including but not limited to text messaging on a cell phone or computer, or text-to-voice conversion for voice mail with a telephone or cell phone. It is contemplated that these variations can be accomplished by including the appropriate service agent objects and code to the control system 12 and/or communications method 82.

It will be understood that the embodiments of the present invention described herein are merely exemplary and that a person skilled in the art may make many variations and modifications without departing from the spirit and scope of the invention. All such variations and modifications are intended to be included within the scope of the invention as defined in the appended claims.

1. A method for communicating document information, the method comprising the steps of: receiving from a first client system a first request to send first document information to a first recipient system set selected from a plurality of recipient systems having disparate communication protocols; receiving from at least one of the first client system and a second client system a second request to send second document information to a second recipient system set selected from the plurality of recipient systems; queuing the first request and the second request into a queue; polling the queue to extract the first request and, substantially concurrently therewith, the second request; retrieving the first document information associated with the first request and, substantially concurrently therewith, the second document information associated with the second request; and sending the first document information to the first recipient system set and, substantially concurrently therewith, the second document information to the second recipient system set.
